(19) United States
(12) Patent Application Publication
(10) Pub. No.: US 2025/0252905 A1
(43) Pub. Date: Aug. 7, 2025

(54) DRIVER AND DISPLAY APPARATUS INCLUDING THE SAME

(71) Applicant: Samsung Display Co., Ltd., Yongin-si (KR)

(72) Inventors: Hyunjoon KIM, Yongin-si (KR); Danwon LIM, Yongin-si (KR); Jaeyong JANG, Yongin-si (KR)

(21) Appl. No.: 18/984,935

(22) Filed: Dec. 17, 2024

(30) Foreign Application Priority Data
Feb. 5, 2024 (KR) 10-2024-0017311

(51) Int. Cl. G09G 3/32

(52) U.S. Cl. CPC G09G 3/32; G09G 2300/0819; G09G 2300/0842; G09G 2300/0861; G09G 2310/0286; G09G 2310/08; G09G 2330/021

(57) ABSTRACT

A driver includes a delay circuit receiving an input signal and at least one of a first clock signal and a second clock signal and outputting the input signal to a first node in response to the at least one of the first clock signal and the second clock signal, a first inverter inverting a signal of the first node and outputting an inverted signal of the signal of the first node to a second node, a second inverter inverting a signal of the second node and outputting an inverted signal of the signal of the second node to a third node, a pull-up circuit pulling up an output signal to a first power voltage in response to the signal of the second node and a pull-down circuit pulling down the output signal to a second power voltage in response to the signal of the third node.

This application claims priority to Korean Patent Application No. 10-2024-0017311, filed on Feb. 5, 2024, and all the benefits accruing therefrom under 35 U.S.C. § 119, the content of which in its entirety is herein incorporated by reference.

### BACKGROUND

### 1. Field

The present invention relates to a driver and a display apparatus including the driver, and more particularly, to a driver including a pull-down circuit having a PMOS transistor to reduce a dead space and a display apparatus including the driver.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver outputs gate signals to the gate lines, the data driver outputs data voltages to the data lines, the emission driver outputs emission signals to the emission lines and the driving controller controls the gate driver, the data driver and the emission driver.

A driver (e.g. the gate driver and/or the emission driver) of the display apparatus may sequentially output signals (e.g. the gate signals and/or the emission signals) to the pixels of the display panel in a unit of a pixel row. The driver may be implemented in a form of a shift register including a plurality of stages to sequentially output the signals in a unit of the pixel row.

Generally, each stage of the driver may include only a single type of transistor, for example, PMOS (P-type metal oxide semiconductor) transistors. When each stage of the driver includes only the PMOS transistors, a bootstrapping operation, in which a voltage of an internal node of the stage is decreased to a voltage lower than a low voltage level, may be performed to output an output signal having the low voltage level.

To avoid the above bootstrapping operation or to reduce the number of transistors, each stage of the driver may include CMOS (complementary metal oxide semiconductor) transistors

When a pull-down circuit of the driver is formed of an NMOS (N-type metal oxide semiconductor) transistor, a threshold voltage of the NMOS transistor may be shifted in a negative direction so that a reliability of an operation of the pull-down circuit may be reduced. In addition, when the pull-down circuit of the driver is formed of an NMOS oxide transistor, a size of the NMOS oxide transistor of the pull-down circuit may be increased due to a lack of mobility of the pull-down circuit so that a dead space of the display panel may be increased.

### SUMMARY

An embodiment of the invention provides a driver including a pull-down circuit including a PMOS transistor which is capable of enhancing a reliability of the driver and reducing a dead space of a display panel.

An embodiment of the invention also provides a display apparatus including the driver.

In an embodiment, the driver includes a delay circuit, a first inverter, a second inverter, a pull-up circuit and a pull-down circuit. The delay circuit is configured to receive an input signal and at least one of a first clock signal and a second clock signal and output the input signal to a first node in response to the at least one of the first clock signal and the second clock signal. The first inverter is configured to invert a signal of the first node and output an inverted signal of the signal of the first node to a second node. The second inverter is configured to invert a signal of the second node and output an inverted signal of the signal of the second node to a third node. The pull-up circuit is configured to pull up an output signal to a first power voltage in response to the signal of the second node. The pull-down circuit is configured to pull down the output signal to a second power voltage in response to the signal of the third node. The first inverter includes at least one NMOS transistor and the second inverter includes at least one NMOS transistor.

In an embodiment, the delay circuit may include a first PMOS transistor including a control electrode configured to receive the second clock signal, a first electrode configured to receive the input signal and a second electrode connected to the first node, and a first NMOS transistor including a control electrode configured to receive the first clock signal, a first electrode configured to receive the input signal and a second electrode connected to the first node.

In an embodiment, the delay circuit may include a first PMOS transistor including a control electrode configured to receive the second clock signal, a first electrode configured to receive the input signal, and a second electrode connected to the first node.

In an embodiment, the delay circuit may include a first NMOS transistor including a control electrode configured to receive the first clock signal, a first electrode configured to receive the input signal, and a second electrode connected to the first node.

In an embodiment, the first inverter may include a second PMOS transistor including a control electrode connected to the first node, a first electrode configured to receive the first power voltage, and a second electrode connected to the second node and a second NMOS transistor including a control electrode connected to the first node, a first electrode connected to the second node and a second electrode configured to receive the second power voltage.

In an embodiment, a material of an active area of the second PMOS transistor may be different from a material of an active area of the second NMOS transistor.

In an embodiment, the active area of the second PMOS transistor may include a polycrystalline silicon. The active area of the second NMOS transistor may include an oxide semiconductor.

In an embodiment, the second inverter may include a third PMOS transistor including a control electrode connected to the second node, a first electrode configured to receive the first power voltage and a second electrode connected to the third node, and a third NMOS transistor including a control electrode connected to the second node, a first electrode connected to the third node and a second electrode configured to receive a third power voltage lower than the second power voltage.

In an embodiment, a material of an active area of the third PMOS transistor may be different from a material of an active area of the third NMOS transistor.

In an embodiment, the pull-up circuit may include a fourth PMOS transistor including a control electrode connected to the second node, a first electrode configured to receive the first power voltage, and a second electrode connected to an output node.

In an embodiment, the pull-down circuit may include a fifth PMOS transistor including a control electrode connected to the third node, a first electrode connected to an output node and a second electrode configured to receive the second power voltage.

In an embodiment, the driver may include a first PMOS transistor including a control electrode configured to receive the second clock signal, a first electrode configured to receive the input signal and a second electrode connected to the first node, a first NMOS transistor including a control electrode configured to receive the first clock signal, a first electrode configured to receive the input signal and a second electrode connected to the first node, a second PMOS transistor including a control electrode connected to the first node, a first electrode configured to receive the first power voltage and a second electrode connected to the second node, a second NMOS transistor including a control electrode connected to the first node, a first electrode connected to the second node and a second electrode configured to receive the second power voltage, a third PMOS transistor including a control electrode connected to the second node, a first electrode configured to receive the first power voltage and a second electrode connected to the third node, a third NMOS transistor including a control electrode connected to the second node, a first electrode connected to the third node and a second electrode configured to receive a third power voltage lower than the second power voltage, a fourth PMOS transistor including a control electrode connected to the second node, a first electrode configured to receive the first power voltage and a second electrode connected to an output node, a fifth PMOS transistor including a control electrode connected to the third node, a first electrode connected to the output node and a second electrode configured to receive the second power voltage, and a first capacitor including a first electrode configured to receive the first power voltage and a second electrode connected to the first node.

In an embodiment, the first inverter may include a second PMOS transistor including a control electrode connected to the first node, a first electrode configured to receive the first power voltage and a second electrode connected to the second node. and a second NMOS transistor including a control electrode connected to the first node, a first electrode connected to the second node and a second electrode configured to receive a third power voltage that is lower than the second power voltage.

In an embodiment, the second inverter may include a third PMOS transistor including a control electrode connected to the second node, a first electrode configured to receive the first power voltage and a second electrode connected to the third node, and a third NMOS transistor including a control electrode connected to the second node, a first electrode connected to a fourth node and a second electrode configured to receive the second power voltage.

In an embodiment, the second inverter may further include a sixth PMOS transistor including a control electrode connected to the fourth node, a first electrode connected to the third node and a second electrode connected to the fourth node.

In an embodiment, the driver may further include a second capacitor including a first electrode connected to the third node and a second electrode connected to an output node.

In an embodiment, the driver may include a first PMOS transistor including a control electrode configured to receive the second clock signal, a first electrode configured to receive the input signal and a second electrode connected to the first node, a first NMOS transistor including a control electrode configured to receive the first clock signal, a first electrode configured to receive the input signal and a second electrode connected to the first node. The driver may also include a second PMOS transistor including a control electrode connected to the first node, a first electrode configured to receive the first power voltage and a second electrode connected to the second node, a second NMOS transistor including a control electrode connected to the first node, a first electrode connected to the second node and a second electrode configured to receive the second power voltage. Additionally, the driver may include a third PMOS transistor including a control electrode connected to the second node, a first electrode configured to receive the first power voltage and a second electrode connected to the third node, a sixth PMOS transistor including a control electrode connected to a fourth node, a first electrode connected to the third node and a second electrode connected to the fourth node, a third NMOS transistor including a control electrode connected to the second node, a first electrode connected to the fourth node and a second electrode configured to receive the second power voltage, a fourth PMOS transistor including a control electrode connected to the second node, a first electrode configured to receive the first power voltage and a second electrode connected to an output node, a fifth PMOS transistor including a control electrode connected to the third node, a first electrode connected to the output node and a second electrode configured to receive the second power voltage. The driver may also include a first capacitor including a first electrode configured to receive the first power voltage and a second electrode connected to the first node, and a second capacitor including a first electrode connected to the third node and a second electrode connected to the output node.

In an embodiment, the display apparatus includes a display panel, a gate driver, a data driver and an emission driver, wherein the display panel includes a pixel. The gate driver is configured to output a gate signal to the pixel, the data driver is configured to output a data voltage to the pixel and the emission driver is configured to output an emission signal to the pixel. The gate driver includes at least one stage, wherein the stage of the gate driver includes a delay circuit configured to receive an input signal and at least one of a first clock signal and a second clock signal and output the input signal to a first node in response to the at least one of the first clock signal and the second clock signal, a first inverter configured to invert a signal of the first node and output an inverted signal of the signal of the first node to a second node, a second inverter configured to invert a signal of the second node and output an inverted signal of the signal of the second node to a third node, a pull-up circuit configured to pull up an output signal to a first power voltage in response to the signal of the second node and a pull-down circuit configured to pull down the output signal to a second power voltage in response to the signal of the third node. The first inverter includes at least one NMOS transistor and the second inverter includes at least one NMOS transistor.

In an embodiment, the pixel may include a P-type switching element and an N-type switching element.

In an embodiment, the pixel may include a first pixel switching element including a control electrode connected to a first pixel node, a first electrode connected to a second pixel node and a second electrode connected to a third pixel node, a second pixel switching element including a control electrode configured to receive a writing gate signal, a first electrode configured to receive the data voltage and a second electrode connected to the second pixel node, a third pixel switching element including a control electrode configured to receive a compensation gate signal, a first electrode connected to the first pixel node and a second electrode connected to the third pixel node, a fourth pixel switching element including a control electrode configured to receive a data initialization gate signal, a first electrode configured to receive an initialization voltage and a second electrode connected to the first pixel node, a fifth pixel switching element including a control electrode configured to receive the emission signal, a first electrode configured to receive a high power voltage and a second electrode connected to the second pixel node, a sixth pixel switching element including a control electrode configured to receive the emission signal, a first electrode connected to the third pixel node and a second electrode connected to an anode electrode of a light emitting element, a seventh pixel switching element including a control electrode configured to receive a light emitting element initialization gate signal, a first electrode configured to receive the initialization voltage and a second electrode connected to the anode electrode of the light emitting element. The pixel may also include a storage capacitor including a first electrode configured to receive the high power voltage and a second electrode connected to the first pixel node and the light emitting element including the anode electrode and a cathode electrode configured to receive a low power voltage.

In an embodiment, the third pixel switching element and the fourth pixel switching element may be N-type transistors. The first pixel switching element, the second pixel switching element, the fifth pixel switching element, the sixth pixel switching element and the seventh pixel switching element may be P-type transistors. The output signal of the stage may be the compensation gate signal.

In an embodiment, the third pixel switching element and the fourth pixel switching element may be N-type transistors. The first pixel switching element, the second pixel switching element, the fifth pixel switching element, the sixth pixel switching element and the seventh pixel switching element may be P-type transistors. The output signal of the stage may be the compensation gate signal and the data initialization gate signal.

In an embodiment, the data initialization gate signal may have a timing earlier than a timing of the compensation gate signal in a frame.

In an embodiment, the third pixel switching element, the fourth pixel switching element and the seventh pixel switching element may be N-type transistors and the first pixel switching element, the second pixel switching element, the fifth pixel switching element and the sixth pixel switching element may be P-type transistors. The output signal of the stage may be the compensation gate signal.

In an embodiment, the third pixel switching element, the fourth pixel switching element and the seventh pixel switching element may be N-type transistors and the first pixel switching element, the second pixel switching element, the fifth pixel switching element and the sixth pixel switching element may be P-type transistors. The output signal of the stage may be the compensation gate signal, the data initialization gate signal and the light emitting element initialization gate signal.

In an embodiment, the display apparatus includes a display panel, a gate driver, a data driver and an emission driver, where the display panel includes a pixel. The gate driver is configured to output a gate signal to the pixel, the data driver is configured to output a data voltage to the pixel, the emission driver is configured to output an emission signal to the pixel and the emission driver includes at least one stage. The stage of the emission driver includes a delay circuit configured to receive an input signal and at least one of a first clock signal and a second clock signal and output the input signal to a first node in response to the at least one of the first clock signal and the second clock signal, a first inverter configured to invert a signal of the first node and output an inverted signal of the signal of the first node to a second node, a second inverter configured to invert a signal of the second node and output an inverted signal of the signal of the second node to a third node, a pull-up circuit configured to pull up an output signal to a first power voltage in response to the signal of the second node and a pull-down circuit configured to pull down the output signal to a second power voltage in response to the signal of the third node. The first inverter includes at least one NMOS transistor and the second inverter includes at least one NMOS transistor.

According to an embodiment of the driver and the display apparatus including the driver, at least one stage may include the inverters, where at least one of the inverters may include the PMOS (P-type metal oxide semiconductor) transistor and the NMOS (N-type metal oxide semiconductor) transistor and the material of the active area of the PMOS transistor included in the at least one of the inverters may be different from the material of the active area of the NMOS transistor included in the at least one of the inverters. Accordingly, the power consumption of the driver and the display apparatus may be reduced.

In an embodiment, the pull-down circuit of the stage includes the PMOS transistor having a high reliability and a high mobility so that the reliability of the driver may be enhanced and the dead space of the display panel may be reduced.

In an embodiment, the low level of the signal applied to the control electrode of the pull-down circuit is lower than the second power voltage applied to the second electrode of the pull-down circuit so that the pull-down circuit may be sufficiently turned on and the reliability of the driver may be further enhanced.

### BRIEF DESCRIPTION OF THE DRAWINGS

The above and other features and advantages of the invention will become more apparent by describing in detailed embodiments thereof with reference to the accompanying drawings, in which:

FIG. 1 is a block diagram illustrating a display apparatus, according to an embodiment;

FIG. 2A is a block diagram illustrating a gate driver of FIG. 1, according to an embodiment;

FIG. 2B is a block diagram illustrating an emission driver of FIG. 1, according to an embodiment;

FIG. 3 is a timing diagram illustrating an example of an operation of the driver of FIG. 2A and FIG. 2B, according to an embodiment;

FIG. 4 is a circuit diagram illustrating a stage of the driver of FIG. 2A and FIG. 2B, according to an embodiment;

FIG. 5 is a timing diagram illustrating an example of an operation of the stage of FIG. 4, according to an embodiment;

FIG. 6 is a circuit diagram illustrating an example of a pixel of a display panel of FIG. 1, according to an embodiment;

FIG. 7 is a timing diagram illustrating an example of input signals of the pixel of FIG. 6, according to an embodiment;

FIG. 8 is a timing diagram illustrating an example of input signals of the pixel of FIG. 6, according to an embodiment;

FIG. 9 is a circuit diagram illustrating an example of a pixel of a display panel of FIG. 1, according to an embodiment;

FIG. 10 is a timing diagram illustrating an example of input signals of the pixel of FIG. 9, according to an embodiment;

FIG. 11 is a timing diagram illustrating an example of input signals of the pixel of FIG. 9, according to an embodiment;

FIG. 12 is a circuit diagram illustrating a stage of a driver of a display apparatus, according to an embodiment;

FIG. 13 is a timing diagram illustrating an example of an operation of the stage of FIG. 12, according to an embodiment;

FIG. 14 is a circuit diagram illustrating a stage of a driver of a display apparatus, according to an embodiment;

FIG. 15 is a circuit diagram illustrating a stage of a driver of a display apparatus, according to an embodiment;

FIG. 16 is a circuit diagram illustrating a stage of a driver of a display apparatus, according to an embodiment;

FIG. 17 is a timing diagram illustrating an example of an operation of the stage of FIG. 16, according to an embodiment;

FIG. 18 is a circuit diagram illustrating a stage of a driver of a display apparatus, according to an embodiment;

FIG. 19 is a circuit diagram illustrating a stage of a driver of a display apparatus, according to an embodiment;

FIG. 20 is a block diagram illustrating an electronic apparatus, according to an embodiment; and

FIG. 21 is a diagram illustrating an example in which the electronic apparatus of FIG. 20 is implemented as a smart phone, according to an embodiment.

### DETAILED DESCRIPTION

Hereinafter, the present inventive concept will be explained in detail with reference to the accompanying drawings.

It will be understood that when an element (or a region, a layer, a portion, or the like) is referred to as being related to another such as being “on”, “connected to” or “coupled to” another element, it may be directly disposed on, connected or coupled to the other element, or intervening elements may be disposed therebetween.

Like reference numerals or symbols refer to like elements throughout. In the drawings, the thickness, the ratio, and the size of the element are exaggerated for effective description of the technical contents. As used herein, the term “and/or” includes any and all combinations of one or more of the associated listed items.

The term “and/or,” may include all combinations of one or more of which associated configurations may define.

It will also be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the scope of the inventive concept. Similarly, a second element, component, region, layer or section may be termed a first element, component, region, layer or section. As used herein, the singular forms, “a”, “an” and “the” are intended to include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

It will be further understood that the terms “comprise”, “includes” and/or “have”, when used in this specification, specify the presence of stated features, integers, steps, operations, elements, components, and/or groups thereof, but do not preclude the presence or addition of one or more other features, integers, steps, operations, elements, components, and/or groups thereof. As used herein, being “disposed directly on” may mean that there is no additional layer, film, region, plate, or the like between a part and another part such as a layer, a film, a region, a plate, or the like. For example, being “disposed directly on” may mean that two layers or two members are disposed without using an additional member such as an adhesive member, therebetween.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

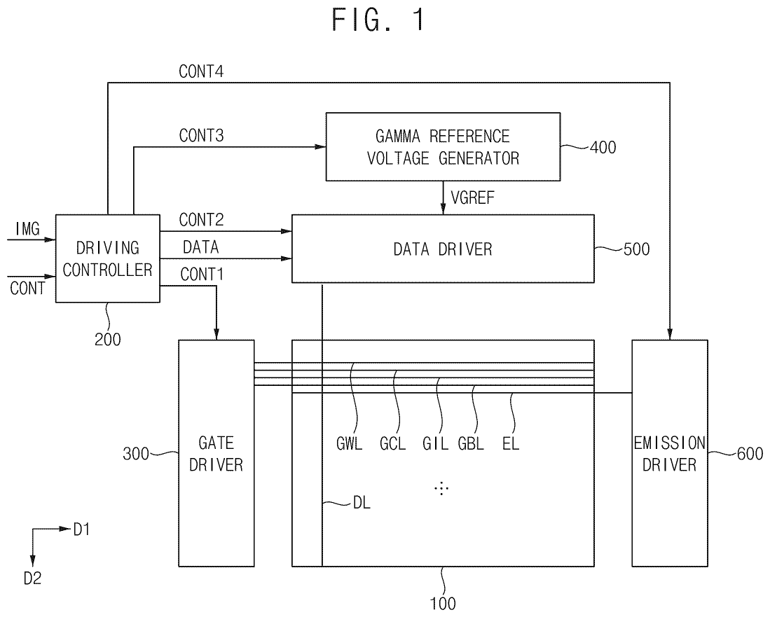

FIG. 1 is a block diagram illustrating a display apparatus, according to an embodiment.

In an embodiment and referring to FIG. 1, the display apparatus includes a display panel 100 and a display panel driver, where the display panel driver includes a driving controller 200, a gate driver 300, a gamma reference voltage generator 400, a data driver 500 and an emission driver 600.

The display panel 100 has a display region on which an image is displayed and a peripheral region disposed adjacent to the display region.

The display panel 100 includes a plurality of gate lines GWL, GCL, GIL and GBL, a plurality of data lines DL, a plurality of emission lines EL and a plurality of pixels electrically connected to the gate lines GWL, GCL, GIL and GBL, the data lines DL and the emission lines EL. The gate lines GWL, GCL, GIL and GBL may extend in a first direction D1, the data lines DL may extend in a second direction D2 crossing the first direction D1 and the emission lines EL may extend in the first direction D1.

The driving controller 200 receives input image data IMG and an input control signal CONT from an external apparatus. For example, the input image data IMG may include red image data, green image data and blue image data. Additionally, the input image data IMG may include white image data. The input image data IMG may also include magenta image data, cyan image data and yellow image data. The input control signal CONT may include a master clock signal and a data enable signal. Additionally, the input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG and outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals for driving the gate lines GWL, GCL, GIL and GBL in response to the first control signal CONT1 received from the driving controller 200. The gate driver 300 may output the gate signals to the gate lines GWL, GCL, GIL and GBL.

The gamma reference voltage generator 400 generates a gamma reference voltage VGREF in response to the third control signal CONT3 received from the driving controller 200 and provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200 and receives the gamma reference voltages VGREF from the gamma reference voltage generator 400. The data driver 500 converts the data signal DATA into data voltages having an analog type using the gamma reference voltages VGREF and outputs the data voltages to the data lines DL.

The emission driver 600 generates emission signals to drive the emission lines EL in response to the fourth control signal CONT4 received from the driving controller 200. The emission driver 600 may output the emission signals to the emission lines EL.

Although an embodiment of the gate driver 300 is shown as being disposed at a first side of the display panel 100 and the emission driver 600 is shown as being disposed at a second side of the display panel 100 opposite to the first side in FIG. 1 for convenience of explanation, the invention is not limited thereto. For example, in an embodiment, both of the gate driver 300 and the emission driver 600 may be disposed at the first side of the display panel 100. For example, in an embodiment, the gate driver 300 and the emission driver 600 may be integrally formed. For example, in an embodiment, both of the gate driver 300 and the emission driver 600 may be disposed at both sides of the display panel 100.

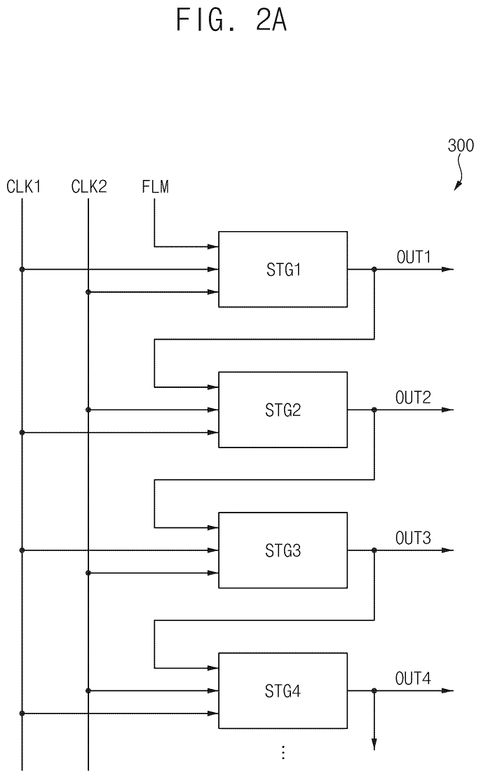

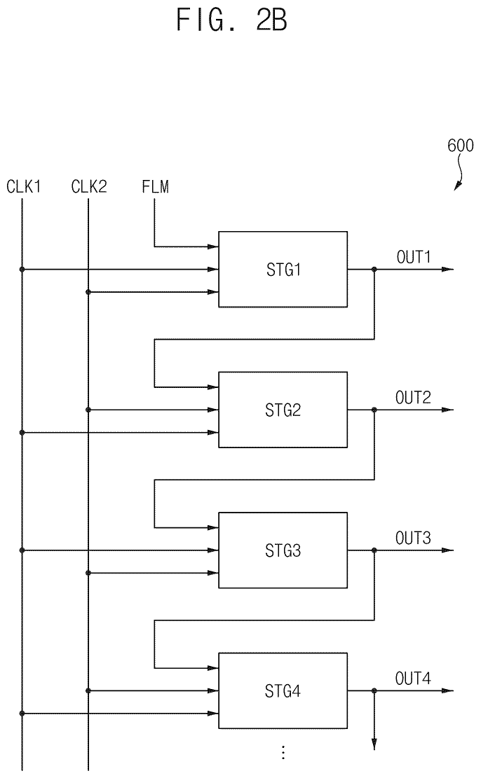

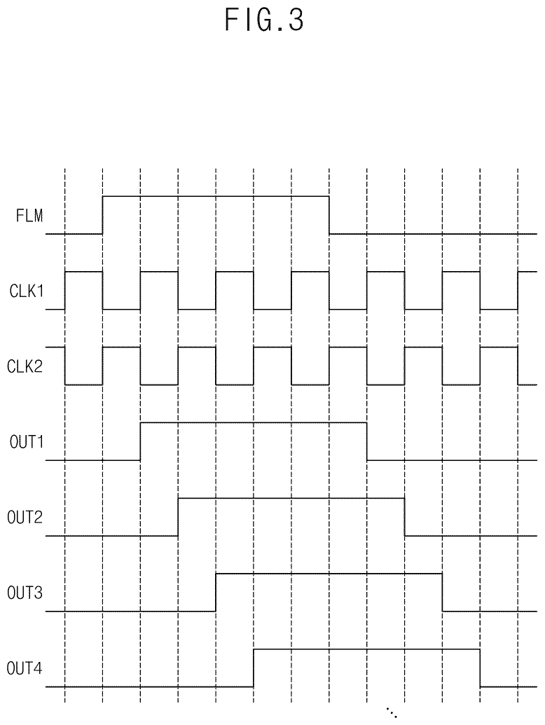

FIG. 2A is a block diagram illustrating a gate driver 300 of FIG. 1, according to an embodiment. FIG. 2B is a block diagram illustrating an emission driver 600 of FIG. 1, according to an embodiment. FIG. 3 is a timing diagram illustrating an example of an operation of the driver of FIG. 2A and FIG. 2B, according to an embodiment.

For example, in an embodiment, the driver may be the gate driver 300 outputting the gate signal in FIG. 2A. For example, in another embodiment, the driver may be the emission driver 600 outputting the emission signal in FIG. 2B. As such, a driver circuit according to an embodiment of the invention may be applied to the gate driver 300 and the emission driver 600.

In an embodiment and referring to FIGS. 2A and 2B, the driver may include a plurality of stages STG1, STG2, STG3, STG4, . . . . and the driver may be implemented as a shift register in which the stages STG1, STG2, STG3, STG4, . . . output sequential output signals OUT1, OUT2, OUT3, OUT4, . . . . In addition, the driver may be included in the display apparatus and may be formed on the display panel 100. For example, the driver may be integrated or disposed on a substrate of the display panel 100.

The stages STG1, STG2, STG3, STG4, . . . may sequentially output the output signals OUT1, OUT2, OUT3, OUT4, . . . based on a start signal FLM, a first clock signal CLK1 and a second clock signal CLK2. A first stage STG1 may receive the start signal FLM as an input signal and each of subsequent stages STG2, STG3, STG4, . . . may receive the output signal of previous stage as the input signal. For example, a second stage STG2 may receive a first output signal OUT1 of the first stage STG1 as the input signal, a third stage STG3 may receive a second output signal OUT2 of the second stage STG2 as the input signal and a fourth stage STG4 may receive a third output signal OUT3 of the third stage STG3 as the input signal.

In addition, in an embodiment, odd-numbered stages STG1, STG3, . . . may start to output the odd-numbered output signals OUT1, OUT3, . . . when the first clock signal CLK1 has a high level and even-numbered stages STG2, STG4, . . . may start to output the even-numbered output signals OUT2, OUT4, . . . when the second clock signal CLK2 has a high level.

For example, in an embodiment and as illustrated in FIGS. 2A to 3, when the first clock signal CLK1 becomes the high level after the start signal FLM becomes a high level, the first stage STG1 may start to output the first output signal OUT1 having a high level. In addition, when the first clock signal CLK1 becomes the high level after the start signal FLM becomes a low level, the first stage STG1 may start to output the first output signal OUT1 having a low level.

When the second clock signal CLK2 becomes the high level after the first output signal OUT1 becomes the high level, the second stage STG2 may start to output the second output signal OUT2 having a high level. In addition, when the second clock signal CLK2 becomes the high level after the first output signal OUT1 becomes a low level, the second stage STG2 may start to output the second output signal OUT2 having a low level.

When the first clock signal CLK1 becomes the high level after the second output signal OUT2 becomes the high level, the third stage STG3 may start to output the third output signal OUT3 having a high level. In addition, when the first clock signal CLK1 becomes the high level after the second output signal OUT2 becomes a low level, the third stage STG3 may start to output the third output signal OUT3 having a low level.

When the second clock signal CLK2 becomes the high level after the third output signal OUT3 becomes the high level, the fourth stage STG4 may start to output the fourth output signal OUT4 having a high level. In addition, when the second clock signal CLK2 becomes the high level after the third output signal OUT3 becomes a low level, the fourth stage STG4 may start to output the fourth output signal OUT4 having a low level.

In this way, the stages STG1, STG2, STG3, STG4, . . . may sequentially output the output signals OUT1, OUT2, OUT3, OUT4, . . . such that the output signals OUT1, OUT2, OUT3, OUT4, . . . are delayed or shifted by half of a cycle of the first clock signal CLK1.

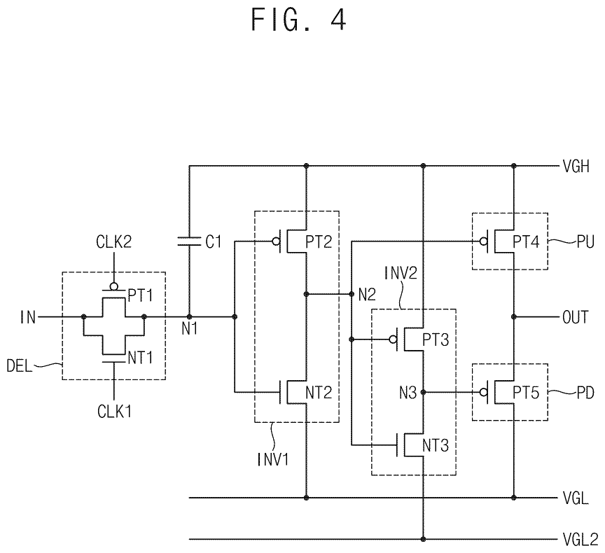

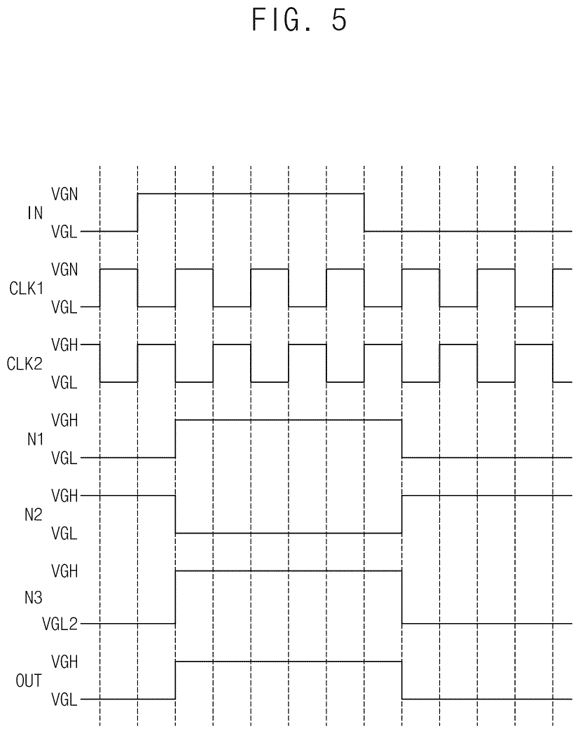

FIG. 4 is a circuit diagram illustrating a stage of the driver of FIG. 2A and FIG. 2B, according to an embodiment. FIG. 5 is a timing diagram illustrating an example of an operation of the stage of FIG. 4, according to an embodiment.

In an embodiment and referring to FIGS. 1 to 5, the stage of the driver includes a delay circuit DEL, a first inverter INV1, a second inverter INV2, a pull-up circuit PU and a pull-down circuit PD.

The delay circuit DEL may receive an input signal IN, the first clock signal CLK1 and the second clock signal CLK2 and output the input signal IN to a first node N1 in response to the first clock signal CLK1 and the second clock signal CLK2. Thus, the input signal IN may be delayed by one horizontal period and transmitted to the first node N1 by the delay circuit DEL.

The first inverter INV1 inverts a signal of the first node N1 and outputs the inverted signal of the signal of the first node N1 to a second node N2. Thus, a signal of the second node N2 may have an inverted waveform of a waveform of the signal of the first node N1. The first inverter INV1 may include at least one NMOS transistor.

The second inverter INV2 inverts the signal of the second node N2 and outputs the inverted signal of the signal of the second node N2 to a third node N3. Thus, a signal of the third node N3 may have an inverted waveform of the waveform of the signal of the second node N2. The second inverter INV2 may include at least one NMOS transistor.

The pull-up circuit PU pulls up an output signal OUT to a first power voltage VGH in response to the signal of the second node N2. The pull-down circuit PD pulls down the output signal OUT to a second power voltage VGL in response to the signal of the third node N3.

In an embodiment, a control signal of the pull-up circuit PU is the signal of the second node N2 and a control signal of the pull-down circuit PD is the signal of the third node N3 which is the inverted signal of the signal of the second node N2. The output signal OUT may have a waveform substantially the same as the waveform of the signal of the third node N3 by the pull-up circuit PU and the pull-down circuit PD. However, a low level of the output signal OUT may be the second power voltage VGL and a low level of the signal of the third node N3 may be a third power voltage VGL2 which is lower than the second power voltage VGL.

In an embodiment, the stage may further include a first capacitor C1 including a first electrode receiving the first power voltage VGH and a second electrode connected to the first node N1.

In an embodiment, the delay circuit DEL may include a first PMOS transistor PT1 including a control electrode receiving the second clock signal CLK2, a first electrode receiving the input signal IN and a second electrode connected to the first node N1 and a first NMOS transistor NT1 including a control electrode receiving the first clock signal CLK1, a first electrode receiving the input signal IN and a second electrode connected to the first node N1.

In an embodiment, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the second power voltage VGL.

In an embodiment, a material of an active area of the second PMOS transistor PT2 may be different from a material of an active area of the second NMOS transistor NT2. For example, the active area of the second PMOS transistor PT2 may include a polycrystalline silicon and the active area of the second NMOS transistor NT2 may include an oxide semiconductor.

In an embodiment, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to the third node N3 and a second electrode receiving the third power voltage VGL2 lower than the second power voltage VGL.

In an embodiment, the low level of the third node N3 is the third power voltage VGL2 which is a lower voltage than the second power voltage VGL in a pull-down operation so that the pull-down circuit PD may be further sufficiently turned on and the reliability of the operation of the pull-down circuit PD may be enhanced.

In an embodiment, a material of an active area of the third PMOS transistor PT3 may be different from a material of an active area of the third NMOS transistor NT3. For example, the active area of the third PMOS transistor PT3 may include a polycrystalline silicon. The active area of the third NMOS transistor NT3 may include an oxide semiconductor.

In an embodiment, the pull-up circuit PU may include a fourth PMOS transistor PT4 including a control electrode connected to the second node N2, a first electrode receiving the first power voltage VGH and a second electrode connected to an output node.

In an embodiment, the pull-down circuit PD may include a fifth PMOS transistor PT5 including a control electrode connected to the third node N3, a first electrode connected to the output node and a second electrode receiving the second power voltage VGL.

In an embodiment, a material of an active area of the fourth PMOS transistor PT4 of the pull-up circuit PU may be substantially the same as a material of an active area of the fifth PMOS transistor PT5 of the pull-down circuit PD.

In an embodiment, the pull-down circuit PD does not include the NMOS transistor but rather the PMOS transistor so that a negative shift of a threshold voltage of the NMOS transistor does not occur and so that an increase of dead space of the display panel 100 due to an increase of a size of the NMOS transistor of the pull-down circuit PD for compensating a mobility of the NMOS transistor does not occur.

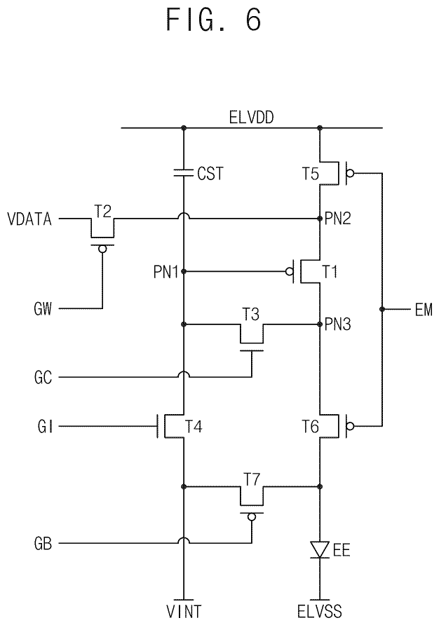

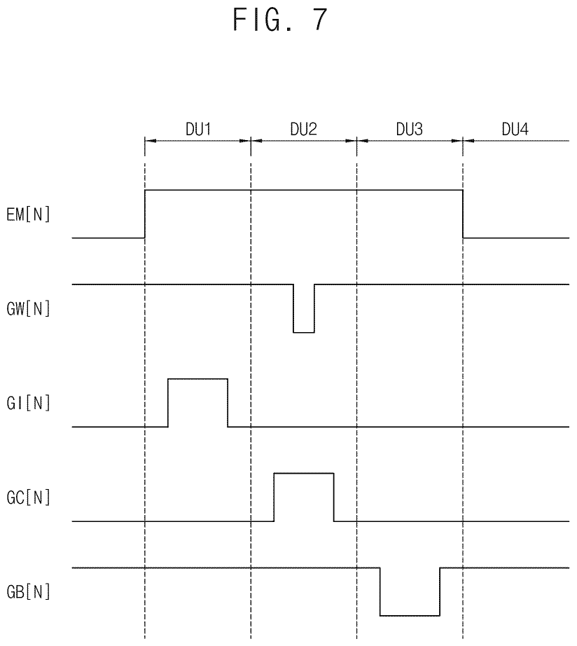

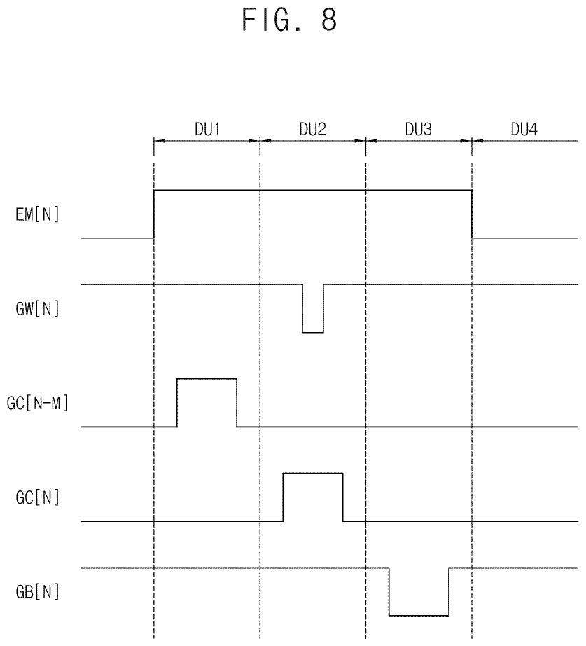

FIG. 6 is a circuit diagram illustrating an example of a pixel of the display panel 100 of FIG. 1, according to an embodiment. FIG. 7 is a timing diagram illustrating an example of input signals of the pixel of FIG. 6, according to an embodiment. FIG. 8 is a timing diagram illustrating an example of input signals of the pixel of FIG. 6, according to an embodiment.

In an embodiment and referring to FIGS. 1 to 8, the display panel 100 includes the plurality of pixels where each pixel includes a light emitting element EE.

In an embodiment, the pixel receives a writing gate signal GW, a compensation gate signal GC, a data initialization gate signal GI, a light emitting element initialization gate signal GB, the data voltage VDATA and the emission signal EM and the light emitting element EE of the pixel emits light corresponding to the level of the data voltage VDATA to display the image.

In an embodiment, the pixel may include a switching element of a first type and a switching element of a second type which is different from the first type. For example, the switching element of the first type may be a P-type transistor and the switching element of the second type may be an N-type transistor.

In an embodiment, the switching element of the first type may be a polycrystalline silicon thin film transistor, such as a low temperature polycrystalline silicon (LTPS) thin film transistor. In another embodiment, the switching element of the second type may be an oxide semiconductor thin film transistor.

In an embodiment, at least one of the pixels may include pixel switching elements T1 to T7, a storage capacitor CST and the light emitting element EE.

The first pixel switching element T1 includes a control electrode connected to a first pixel node PN1, a first electrode connected to a second pixel node PN2 and a second electrode connected to a third pixel node PN3.

The second pixel switching element T2 includes a control electrode receiving the writing gate signal GW, a first electrode receiving the data voltage VDATA and a second electrode connected to the second pixel node PN2.

The third pixel switching element T3 includes a control electrode receiving the compensation gate signal GC, a first electrode connected to the first pixel node PN1 and a second electrode connected to the third pixel node PN3.

The fourth pixel switching element T4 includes a control electrode receiving the data initialization gate signal GI, a first electrode receiving an initialization voltage VINT and a second electrode connected to the first pixel node PN1.

The fifth pixel switching element T5 includes a control electrode receiving the emission signal EM, a first electrode receiving a high power voltage ELVDD and a second electrode connected to the second pixel node PN2.

The sixth pixel switching element T6 includes a control electrode receiving the emission signal EM, a first electrode connected to the third pixel node PN3 and a second electrode connected to an anode electrode of the light emitting element EE.

The seventh pixel switching element T7 includes a control electrode receiving the light emitting element initialization gate signal GB, a first electrode receiving the initialization voltage VINT and a second electrode connected to the anode electrode of the light emitting element EE.

The storage capacitor CST includes a first electrode receiving the high power voltage ELVDD and a second electrode connected to the first pixel node PN1.

The light emitting element EE includes the anode electrode connected to the second electrode of the sixth pixel switching element T6 and a cathode electrode receiving a low power voltage ELVSS.

In an embodiment, the third pixel switching element T3 and the fourth pixel switching element T4 may be N-type transistors. The first pixel switching element T1, the second pixel switching element T2, the fifth pixel switching element T5, the sixth pixel switching element T6 and the seventh pixel switching element T7 may be P-type transistors.

In an embodiment and referring to FIG. 7, during a first duration DU1, the first pixel node PN1 and the storage capacitor CST are initialized in response to the data initialization gate signal GI. During a second duration DU2, a threshold voltage |VTH| of the first pixel switching element T1 is compensated and the data voltage VDATA of which the threshold voltage |VTH| is compensated is written to the first pixel node PN1 in response to the writing gate signals GW and the compensation gate signal GC. During a third duration DU3, the anode electrode of the light emitting element EE is initialized in response to the light emitting element initialization gate signal GB. During a fourth duration DU4, the light emitting element EE emits the light in response to the emission signal EM so that the display panel 100 displays the image.

Although an emission off duration of the emission signal EM corresponds to durations DU1, DU2 and DU3 in the present embodiment, the invention is not limited thereto. The emission off duration of the emission signal EM may be set to include the data writing duration DU2 and the emission off duration of the emission signal EM may be longer than a sum of the first to third durations DU1, DU2 and DU3.

During the first duration DU1, the data initialization gate signal GI may have an active level. For example, the active level of the data initialization gate signal GI may be a high level. When the data initialization gate signal GI has the active level, the fourth pixel switching element T4 is turned on so that the initialization voltage VINT may be applied to the first pixel node PN1.

During the second duration DU2, the writing gate signal GW and the compensation gate signal GC may have an active level. For example, in an embodiment, the active level of the writing gate signal GW may be a low level and the active level of the compensation gate signal GC may be a high level. When the writing gate signal GW and the compensation gate signal GC have the active level, the second pixel switching element T2 and the third pixel switching element T3 are turned on. In addition, the first pixel switching element T1 is turned on in response to the initialization voltage VINT.

A voltage which is subtracted from an absolute value |VTH| of the threshold voltage of the first pixel switching element T1 from the data voltage VDATA may be charged at the first pixel node PN1 along a path generated by the pixel switching elements T1, T2 and T3.

During the third duration DU3, the light emitting element initialization gate signal GB may have an active level. In an embodiment, the active level of the light emitting element initialization gate signal GB may be a low level. When the light emitting element initialization gate signal GB has the active level, the seventh pixel switching element T7 is turned on so that the initialization voltage VINT may be applied to the anode electrode of the light emitting element EE.

Although, the initialization voltage applied to the fourth pixel switching element T4 is the same as the initialization voltage applied to the seventh pixel switching element T7 in the present embodiment, the invention is not limited thereto. In an embodiment, the initialization voltage applied to the fourth pixel switching element T4 may be different from the initialization voltage applied to the seventh pixel switching element T7.

During the fourth duration DU4, the emission signal EM may have an active level. For example, in an embodiment, the active level of the emission signal EM may be a low level. When the emission signal EM has the active level, the fifth pixel switching element T5 and the sixth pixel switching element T6 are turned on. In addition, the first pixel switching element T1 is turned on by the data voltage VDATA.

A driving current flows through the fifth pixel switching element T5, the first pixel switching element T1 and the sixth pixel switching element T6 to drive the light emitting element EE. An intensity of the driving current may be determined by the level of the data voltage VDATA and a luminance of the light emitting element EE is determined by the intensity of the driving current.

In FIG. 7, [N] indicates a signal of a present stage. A signal of a previous stage or a signal of a next stage are not applied to the pixel circuit in FIGS. 6 and 7 so that “[N]” can be omitted in FIG. 7.

In an embodiment, the output signal OUT of the stage circuit of FIG. 4 may be the compensation gate signal GC applied to the third pixel switching element T3.

A timing diagram of FIG. 8 may be substantially the same as the timing diagram of FIG. 7 with the exception that the data initialization gate signal GI and the compensation gate signal GC are generated from the same driver. Thus, repetitive explanations elements will be omitted.

In FIG. 8, [N] indicates a signal of a present stage and [N-M] indicates a signal of an M-th previous stage. Thus, “[N]” for the signal of the present stage can be omitted.

In an embodiment, the output signal OUT of the stage circuit of FIG. 4 may be the compensation gate signal GC[N] applied to the third pixel switching element T3 and the data initialization gate signal GC[N-M] applied to the fourth pixel switching element T4.

In an embodiment and as shown in FIG. 8, the data initialization gate signal GC[N-M] may have a timing earlier than a timing of the compensation gate signal GC[N] in a frame.

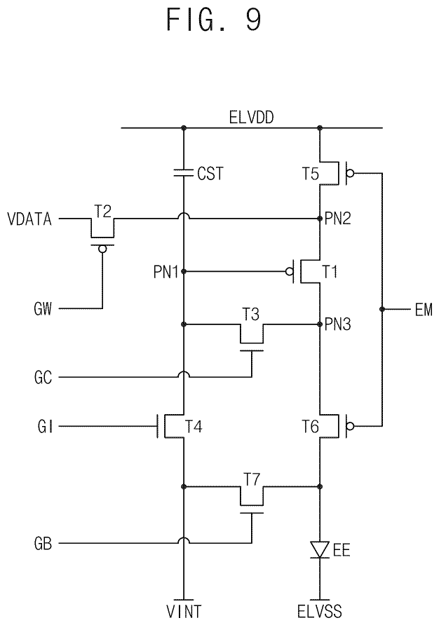

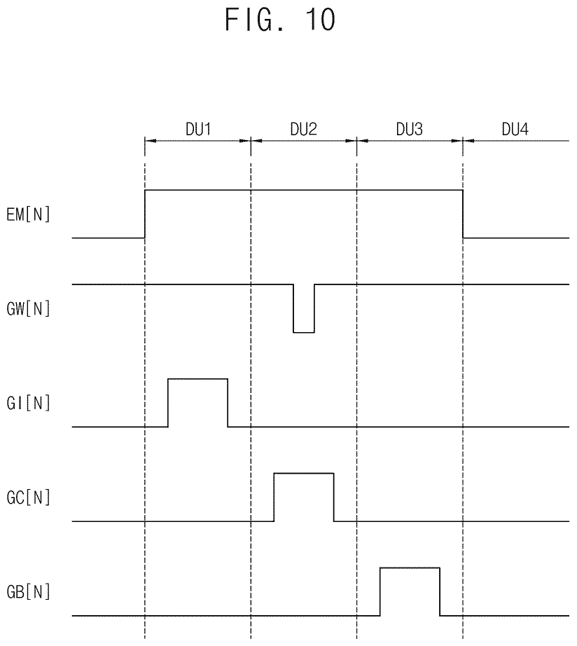

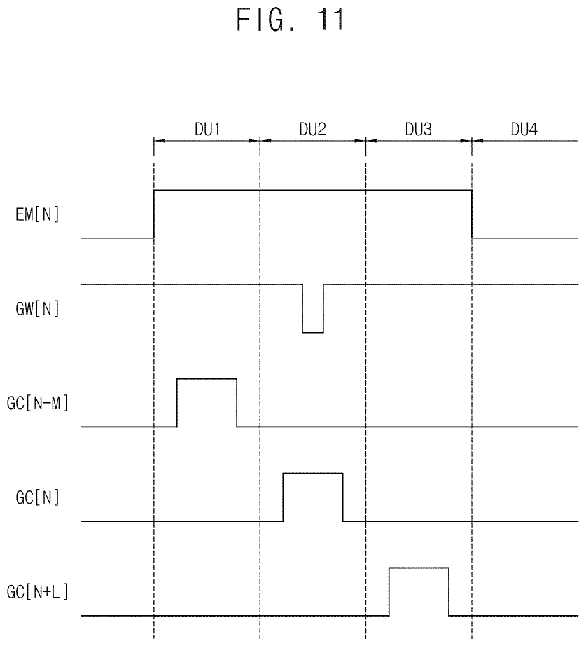

FIG. 9 is a circuit diagram illustrating an example of a pixel of a display panel 100 of FIG. 1, according to an embodiment. FIG. 10 is a timing diagram illustrating an example of input signals of the pixel of FIG. 9, according to an embodiment. FIG. 11 is a timing diagram illustrating an example of input signals of the pixel of FIG. 9, according to an embodiment.

A pixel circuit of FIG. 9 may be substantially the same as the pixel circuit of FIG. 6 with the exception that the seventh pixel switching element T7 is an N-type transistor. Thus, repetitive explanations elements will be omitted.

In an embodiment and referring to FIGS. 1 to 5 and 9 to 11, the display panel 100 includes the plurality of pixels, where each pixel includes a light emitting element EE.

In an embodiment, the pixel receives a writing gate signal GW, a compensation gate signal GC, a data initialization gate signal GI, a light emitting element initialization gate signal GB, the data voltage VDATA and the emission signal EM and the light emitting element EE of the pixel emits light corresponding to the level of the data voltage VDATA to display the image.

In an embodiment, the pixel may include a switching element of a first type and a switching element of a second type which is different from the first type. For example, in an embodiment, the switching element of the first type may be a P-type transistor and the switching element of the second type may be an N-type transistor.

In an embodiment, the switching element of the first type may be a polycrystalline silicon thin film transistor. For example, the switching element of the first type may be a low temperature polycrystalline silicon (LTPS) thin film transistor and the switching element of the second type may be an oxide semiconductor thin film transistor.

In an embodiment, at least one of the pixels may include pixel switching elements T1 to T7, a storage capacitor CST and the light emitting element EE.

In an embodiment, the third pixel switching element T3, the fourth pixel switching element T4 and the seventh pixel switching element T7 may be N-type transistors and the first pixel switching element T1, the second pixel switching element T2, the fifth pixel switching element T5 and the sixth pixel switching element T6 may be P-type transistors.

In an embodiment and referring to FIG. 10, during a first duration DU1, the first pixel node PN1 and the storage capacitor CST are initialized in response to the data initialization gate signal GI. During a second duration DU2, a threshold voltage |VTH| of the first pixel switching element T1 is compensated and the data voltage VDATA of which the threshold voltage |VTH| is compensated is written to the first pixel node PN1 in response to the writing gate signals GW and the compensation gate signal GC. During a third duration DU3, the anode electrode of the light emitting element EE is initialized in response to the light emitting element initialization gate signal GB and during a fourth duration DU4, the light emitting element EE emits the light in response to the emission signal EM so that the display panel 100 displays the image.

In an embodiment, during the third duration DU3, the light emitting element initialization gate signal GB may have an active level. For example, the active level of the light emitting element initialization gate signal GB may be a high level. When the light emitting element initialization gate signal GB has the active level, the seventh pixel switching element T7 is turned on so that the initialization voltage VINT may be applied to the anode electrode of the light emitting element EE.

In FIG. 10, [N] indicates a signal of a present stage. A signal of a previous stage or a signal of a next stage are not applied to the pixel circuit in FIGS. 9 and 10 so that “[N]” can be omitted in FIG. 10.

In an embodiment, the output signal OUT of the stage circuit of FIG. 4 may be the compensation gate signal GC applied to the third pixel switching element T3.

A timing diagram of FIG. 11 may be substantially the same as the timing diagram of FIG. 10 with the exception that the data initialization gate signal GI, the compensation gate signal GC and the light emitting element initialization gate signal GB are generated from the same driver. Thus, repetitive explanations elements will be omitted.

In FIG. 11, [N] indicates a signal of a present stage, [N-M] indicates a signal of an M-th previous stage and [N+L] indicates a signal of an L-th next stage. Thus, “[N]” for the signal of the present stage can be omitted.

In an embodiment, the output signal OUT of the stage circuit of FIG. 4 may be the compensation gate signal GC[N] applied to the third pixel switching element T3, the data initialization gate signal GC[N-M] applied to the fourth pixel switching element T4 and the light emitting element initialization gate signal GC[N+L] applied to the seventh pixel switching element T7.

As shown in FIG. 11, the data initialization gate signal GC[N-M] may have a timing that is earlier than a timing of the compensation gate signal GC[N] in a frame. In addition, the light emitting element initialization gate signal GC[N+L] may have a timing that is later than a timing of the compensation gate signal GC[N] in the frame.

According to an embodiment, at least one stage may include the inverters INV1 and INV2, at least one of the inverters INV1 and INV2 may include the PMOS (P-type metal oxide semiconductor) transistor and the NMOS (N-type metal oxide semiconductor) transistor and the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In an embodiment, the pull-down circuit PD of the stage includes the PMOS transistor PT5 having a high reliability and a high mobility so that the reliability of the driver may be enhanced and the dead space of the display panel 100 may be reduced.

In an embodiment, the low level of the signal applied to the control electrode of the pull-down circuit PD is the third power voltage VGL2 which is lower than the second power voltage VGL applied to the second electrode of the pull-down circuit PD so that the pull-down circuit PD may be sufficiently turned on and accordingly, the reliability of the driver may be further enhanced.

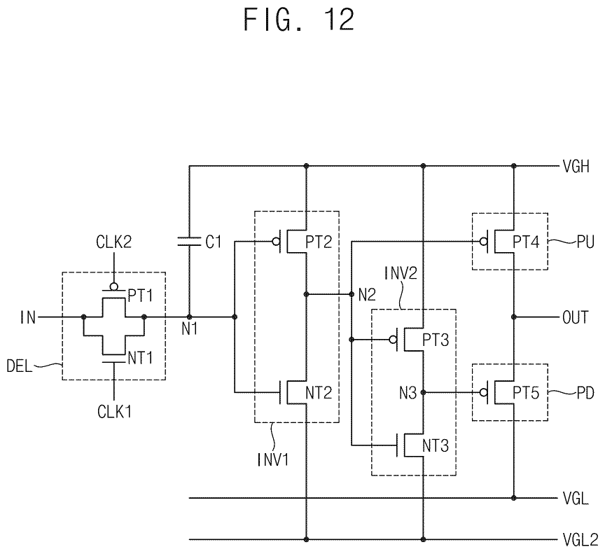

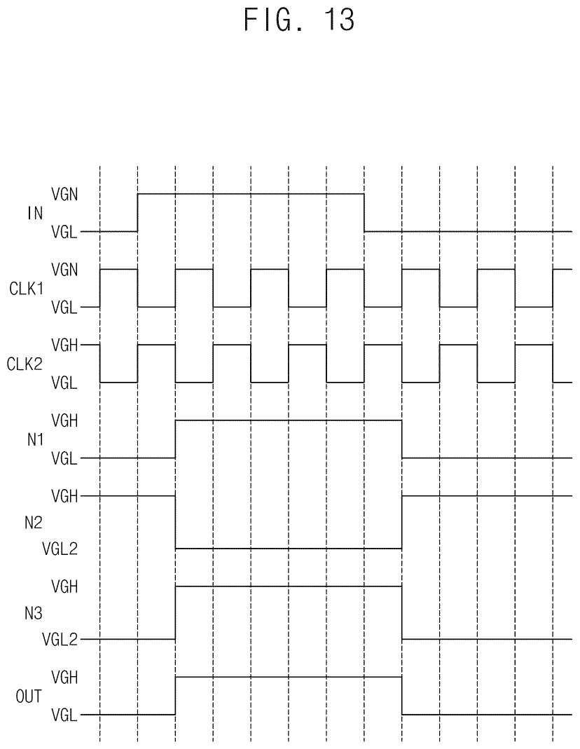

FIG. 12 is a circuit diagram illustrating a stage of a driver of a display apparatus, according to an embodiment. FIG. 13 is a timing diagram illustrating an example of an operation of the stage of FIG. 12, according to an embodiment.

In an embodiment, the driver and the display apparatus including the driver are substantially the same as the driver and the display apparatus including the driver of the previous embodiment explained referring to FIGS. 1 to 11 with the exception of the circuit structure of the first inverter. Thus, the same reference numerals will be used to refer to the same or like parts as those described in the previous embodiment of FIGS. 1 to 11 and any repetitive explanation concerning the above elements will be omitted.

In an embodiment and referring to FIGS. 1 to 3 and 6 to 13, the display apparatus includes a display panel 100 and a display panel driver, where the display panel driver includes a driving controller 200, a gate driver 300, a gamma reference voltage generator 400, a data driver 500 and an emission driver 600.

For example, in an embodiment, the driver may be the gate driver 300 outputting the gate signal in FIG. 2A. For example, in an embodiment, the driver may be the emission driver 600 outputting the emission signal in FIG. 2B. As such, a driver circuit according to the invention may be applied to the gate driver 300 and the emission driver 600.

In an embodiment, the stage of the driver includes a delay circuit DEL, a first inverter INV1, a second inverter INV2, a pull-up circuit PU and a pull-down circuit PD.

In an embodiment, the stage may further include a first capacitor C1 including a first electrode receiving the first power voltage VGH and a second electrode connected to the first node N1.

In an embodiment, the delay circuit DEL may include a first PMOS transistor PT1 including a control electrode receiving the second clock signal CLK2, a first electrode receiving the input signal IN and a second electrode connected to the first node N1 and a first NMOS transistor NT1 including a control electrode receiving the first clock signal CLK1, a first electrode receiving the input signal IN and a second electrode connected to the first node N1.

In an embodiment, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the third power voltage VGL2 which is lower than the second power voltage VGL.

In an embodiment, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to the third node N3 and a second electrode receiving the third power voltage VGL2.

In an embodiment, the low level of the third node N3 is the third power voltage VGL2 which is lower than the second power voltage VGL in a pull-down operation so that the pull-down circuit PD may be sufficiently turned on and accordingly the reliability of the operation of the pull-down circuit PD may be enhanced.

In an embodiment, the pull-up circuit PU may include a fourth PMOS transistor PT4 including a control electrode connected to the second node N2, a first electrode receiving the first power voltage VGH and a second electrode connected to an output node.

In an embodiment, the pull-down circuit PD may include a fifth PMOS transistor PT5 including a control electrode connected to the third node N3, a first electrode connected to the output node and a second electrode receiving the second power voltage VGL.

In an embodiment, the pull-down circuit PD does not include the NMOS transistor, but does include the PMOS transistor so that a negative shift of a threshold voltage of the NMOS transistor does not occur and so that an increase of dead space of the display panel 100 due to an increase of a size of the NMOS transistor for compensating a mobility of the NMOS transistor does not occur.

According to an embodiment, at least one stage may include the inverters INV1 and INV2, at least one of the inverters INV1 and INV2 may include the PMOS (P-type metal oxide semiconductor) transistor and the NMOS (N-type metal oxide semiconductor) transistor and the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In an embodiment, the pull-down circuit PD of the stage includes the PMOS transistor PT5 having a high reliability and a high mobility so that the reliability of the driver may be enhanced and the dead space of the display panel 100 may be reduced.

In an embodiment, the low level of the signal applied to the control electrode of the pull-down circuit PD is the third power voltage VGL2 which is lower than the second power voltage VGL applied to the second electrode of the pull-down circuit PD so that the pull-down circuit PD may be sufficiently turned on and accordingly, so the reliability of the driver may be further enhanced.

FIG. 14 is a circuit diagram illustrating a stage of a driver of a display apparatus, according to an embodiment.

The driver and the display apparatus, including the driver according to the present embodiment, are substantially the same as the driver and the display apparatus including the driver of the previous embodiment explained referring to FIGS. 1 to 11 with the exception of the circuit structure of the delay circuit. Thus, the same reference numerals will be used to refer to the same or like parts as those described in the previous embodiment of FIGS. 1 to 11 and any repetitive explanation concerning the above elements will be omitted.

In an embodiment and referring to FIGS. 1 to 3, 6 to 11 and 14, the display apparatus includes a display panel 100 and a display panel driver. The display panel driver includes a driving controller 200, a gate driver 300, a gamma reference voltage generator 400, a data driver 500 and an emission driver 600.

In an embodiment, the driver may be the gate driver 300 outputting the gate signal in FIG. 2A. In an embodiment, the driver may be the emission driver 600 outputting the emission signal in FIG. 2B. As such, a driver circuit according to the invention may be applied to the gate driver 300 and the emission driver 600.

In an embodiment, the stage of the driver includes a delay circuit DEL, a first inverter INV1, a second inverter INV2, a pull-up circuit PU and a pull-down circuit PD.

In an embodiment, the stage may further include a first capacitor C1 including a first electrode receiving the first power voltage VGH and a second electrode connected to the first node N1.

In an embodiment, the delay circuit DEL may include a first PMOS transistor PT1 including a control electrode receiving the second clock signal CLK2, a first electrode receiving the input signal IN and a second electrode connected to the first node N1.

Even if the delay circuit DEL includes only one transistor PT1, the delay circuit DEL may perform substantially the same operation as the delay circuit DEL of FIG. 4. Thus, when the delay circuit DEL includes only one transistor PT1 as illustrated in FIG. 14, the number of transistors may be reduced and the dead space of the display panel 100 may be reduced.

In an embodiment, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the second power voltage VGL.

In an embodiment, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to the third node N3 and a second electrode receiving the third power voltage VGL2 which is lower than the second power voltage VGL.

In an embodiment, the low level of the third node N3 is the third power voltage VGL2 which is lower than the second power voltage VGL in a pull-down operation so that the pull-down circuit PD may be sufficiently turned on and so that the reliability of the operation of the pull-down circuit PD may be enhanced.

In an embodiment, the pull-up circuit PU may include a fourth PMOS transistor PT4 including a control electrode connected to the second node N2, a first electrode receiving the first power voltage VGH and a second electrode connected to an output node.

In an embodiment, the pull-down circuit PD may include a fifth PMOS transistor PT5 including a control electrode connected to the third node N3, a first electrode connected to the output node and a second electrode receiving the second power voltage VGL.

In an embodiment, the pull-down circuit PD does not include the NMOS transistor but does include the PMOS transistor so that a negative shift of a threshold voltage of the NMOS transistor does not occur and so that an increase of dead space of the display panel 100 due to an increase of a size of the NMOS transistor of the pull-down circuit PD for compensating a mobility of the NMOS transistor does not occur.

According to an embodiment, at least one stage may include the inverters INV1 and INV2, where at least one of the inverters INV1 and INV2 may include the PMOS (P-type metal oxide semiconductor) transistor and the NMOS (N-type metal oxide semiconductor) transistor and where the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In addition, the pull-down circuit PD of the stage includes the PMOS transistor PT5 having a high reliability and a high mobility so that the reliability of the driver may be enhanced and the dead space of the display panel 100 may be reduced.

In addition, the low level of the signal applied to the control electrode of the pull-down circuit PD is the third power voltage VGL2 which is lower than the second power voltage VGL that is applied to the second electrode of the pull-down circuit PD so that the pull-down circuit PD may be sufficiently turned on and accordingly, so that the reliability of the driver may be further enhanced.

FIG. 15 is a circuit diagram illustrating a stage of a driver of a display apparatus, according to an embodiment.

The driver and the display apparatus, including the driver according to the present embodiment, are substantially the same as the driver and the display apparatus including the driver of the previous embodiment explained referring to FIGS. 1 to 11 with the exception of the circuit structure of the delay circuit. Thus, the same reference numerals will be used to refer to the same or like parts as those described in the previous embodiment of FIGS. 1 to 11 and any repetitive explanation concerning the above elements will be omitted.

In an embodiment and referring to FIGS. 1 to 3, 6 to 11 and 15, the display apparatus includes a display panel 100 and a display panel driver. The display panel driver includes a driving controller 200, a gate driver 300, a gamma reference voltage generator 400, a data driver 500 and an emission driver 600.

In an embodiment, the driver may be the gate driver 300 outputting the gate signal in FIG. 2A. In an embodiment, t, the driver may be the emission driver 600 outputting the emission signal in FIG. 2B. As such, a driver circuit according to the invention may be applied to the gate driver 300 and the emission driver 600.

In an embodiment, the stage of the driver includes a delay circuit DEL, a first inverter INV1, a second inverter INV2, a pull-up circuit PU and a pull-down circuit PD.

In an embodiment, the stage may further include a first capacitor C1 including a first electrode receiving the first power voltage VGH and a second electrode connected to the first node N1.

In an embodiment, the delay circuit DEL may include a first NMOS transistor NT1 including a control electrode receiving the first clock signal CLK1, a first electrode receiving the input signal IN and a second electrode connected to the first node N1.

Even if the delay circuit DEL includes only one transistor NT1, the delay circuit DEL may perform substantially the same operation as the delay circuit DEL of FIG. 4. Thus, when the delay circuit DEL includes only one transistor NT1 as illustrated in FIG. 15, the number of transistors may be reduced and the dead space of the display panel 100 may be reduced.

In an embodiment, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the second power voltage VGL.

In an embodiment, t, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to the third node N3 and a second electrode receiving the third power voltage VGL2 which is lower than the second power voltage VGL.

In an embodiment, the low level of the third node N3 is the third power voltage VGL2 which is lower than the second power voltage VGL in a pull-down operation so that the pull-down circuit PD may be sufficiently turned on and accordingly the reliability of the operation of the pull-down circuit PD may be enhanced.

In an embodiment, the pull-up circuit PU may include a fourth PMOS transistor PT4 including a control electrode connected to the second node N2, a first electrode receiving the first power voltage VGH and a second electrode connected to an output node.

In an embodiment, t, the pull-down circuit PD may include a fifth PMOS transistor PT5 including a control electrode connected to the third node N3, a first electrode connected to the output node and a second electrode receiving the second power voltage VGL.

In an embodiment, the pull-down circuit PD does not include the NMOS transistor but does include the PMOS transistor so that a negative shift of a threshold voltage of the NMOS transistor does not occur and so that an increase of dead space of the display panel 100 due to an increase of a size of the NMOS transistor of the pull-down circuit PD for compensating a mobility of the NMOS transistor does not occur.

According to an embodiment, at least one stage may include the inverters INV1 and INV2, at least one of the inverters INV1 and INV2 may include the PMOS (P-type metal oxide semiconductor) transistor and the NMOS (N-type metal oxide semiconductor) transistor and the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In an embodiment, the pull-down circuit PD of the stage includes the PMOS transistor PT5 having a high reliability and a high mobility so that the reliability of the driver may be enhanced and the dead space of the display panel 100 may be reduced.

In an embodiment, the low level of the signal applied to the control electrode of the pull-down circuit PD is the third power voltage VGL2 which is lower than the second power voltage VGL applied to the second electrode of the pull-down circuit PD so that the pull-down circuit PD may be sufficiently turned on and accordingly, the reliability of the driver may be further enhanced.

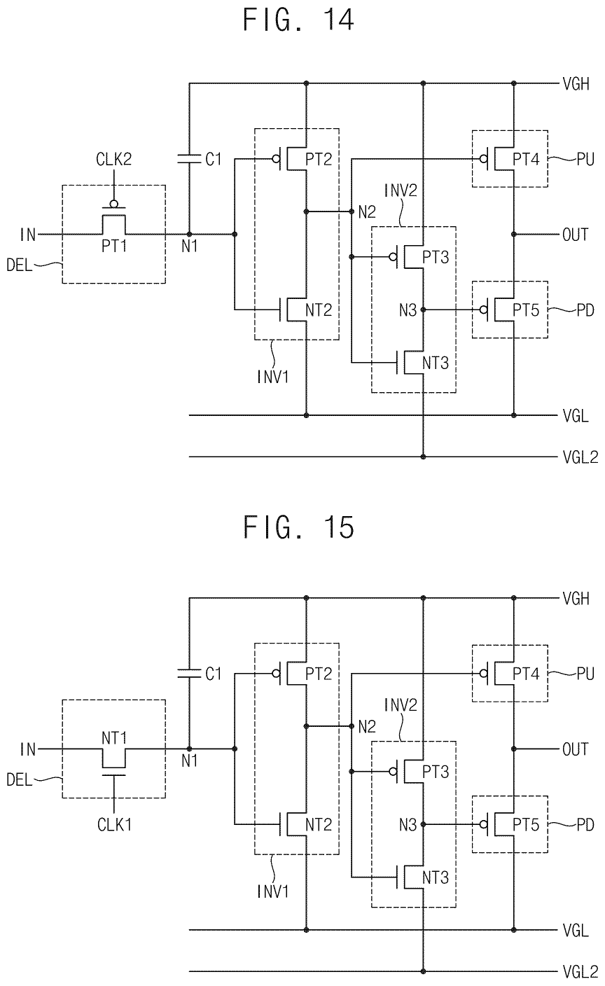

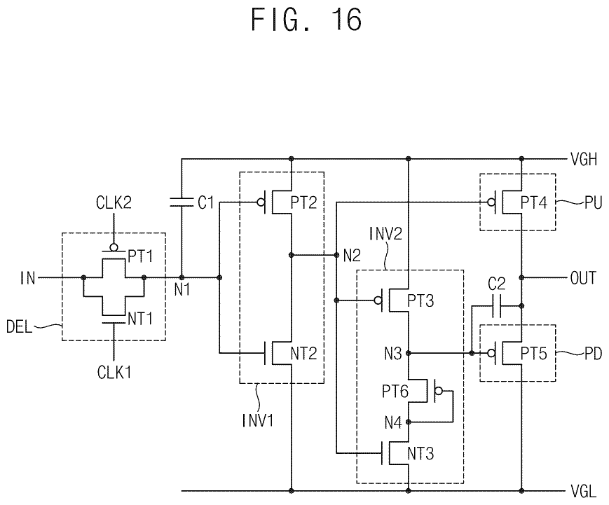

FIG. 16 is a circuit diagram illustrating a stage of a driver of a display apparatus, according to an embodiment. FIG. 17 is a timing diagram illustrating an example of an operation of the stage of FIG. 16, according to an embodiment.

The driver and the display apparatus including the driver according to the present embodiment are substantially the same as the driver and the display apparatus including the driver of the previous embodiment explained referring to FIGS. 1 to 11 with the exception of the circuit structure of the second inverter and a second capacitor. Thus, the same reference numerals will be used to refer to the same or like parts as those described in the previous embodiment of FIGS. 1 to 11 and any repetitive explanation concerning the above elements will be omitted.

In an embodiment and referring to FIGS. 1 to 3, 6 to 11, 16 and 17, the display apparatus includes a display panel 100 and a display panel driver, where the display panel driver includes a driving controller 200, a gate driver 300, a gamma reference voltage generator 400, a data driver 500 and an emission driver 600.

In an embodiment, the driver may be the gate driver 300 outputting the gate signal in FIG. 2A. In an embodiment, the driver may be the emission driver 600 outputting the emission signal in FIG. 2B. As such, a driver circuit according to the invention may be applied to the gate driver 300 and the emission driver 600.

In an embodiment, the stage of the driver includes a delay circuit DEL, a first inverter INV1, a second inverter INV2, a pull-up circuit PU and a pull-down circuit PD.

In an embodiment, the delay circuit DEL may receive the input signal IN, the first clock signal CLK1 and the second clock signal CLK2 and output the input signal IN to a first node N1 in response to the first clock signal CLK1 and the second clock signal CLK2. Thus, the input signal IN may be delayed by one horizontal period and transmitted to the first node N1 by the delay circuit DEL.

In an embodiment, the first inverter INV1 inverts a signal of the first node N1 and outputs the inverted signal of the signal of the first node N1 to a second node N2. Thus, a signal of the second node N2 may have an inverted waveform of a waveform of the signal of the first node N1. The first inverter INV1 may include at least one NMOS transistor.

In an embodiment, the second inverter INV2 inverts the signal of the second node N2 and outputs the inverted signal of the signal of the second node N2 to a third node N3. Thus, a signal of the third node N3 may have an inverted waveform of the waveform of the signal of the second node N2. The second inverter INV2 may include at least one NMOS transistor.

In an embodiment, the pull-up circuit PU pulls up an output signal OUT to a first power voltage VGH in response to the signal of the second node N2. The pull-down circuit PD pulls down the output signal OUT to a second power voltage VGL in response to the signal of the third node N3.

In an embodiment, a control signal of the pull-up circuit PU is the signal of the second node N2 and a control signal of the pull-down circuit PD is the signal of the third node N3 which is the inverted signal of the signal of the second node N2. The output signal OUT may have a waveform that is substantially the same as the waveform of the signal of the third node N3 by the pull-up circuit PU and the pull-down circuit PD. However, a low level of the output signal OUT may be the second power voltage VGL and a low level of the signal of the third node N3 may also be the second power voltage VGL.

In an embodiment, the stage may further include a first capacitor C1 including a first electrode receiving the first power voltage VGH and a second electrode connected to the first node N1.

In an embodiment, the delay circuit DEL may include a first PMOS transistor PT1 including a control electrode receiving the second clock signal CLK2, a first electrode receiving the input signal IN and a second electrode connected to the first node N1 and a first NMOS transistor NT1 including a control electrode receiving the first clock signal CLK1, a first electrode receiving the input signal IN and a second electrode connected to the first node N1.

In an embodiment, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the second power voltage VGL.

In an embodiment, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to a fourth node N4 and a second electrode receiving the second power voltage VGL.

In an embodiment, the second inverter INV2 may further include a sixth PMOS transistor PT6 including a control electrode connected to the fourth node N4, a first electrode connected to the third node N3 and a second electrode connected to the fourth node N4.

In an embodiment, the stage of the driver may further include a second capacitor C2 including a first electrode connected to the third node N3 and a second electrode connected to an output node.

In an embodiment, right before the signal of the third node N3 decreases from the high level VGH to the low level VGL, the first electrode of the second capacitor C2 may have the high level VGH which is the high level of the signal of the third node N3 and the second electrode of the second capacitor C2 may have the high level VGH which is the high level of the output signal OUT.

In an embodiment, right after the signal of the third node N3 decreases from the high level VGH to the low level VGL by the inverting operation of the first inverter INV1, the first electrode of the second capacitor C2 may have the low level VGL which is the low level of the signal of the third node N3 and the second electrode of the second capacitor C2 may have the high level VGH which is the high level of the output signal OUT. Herein, a voltage difference between the both electrodes of the second capacitor C2 is VGH-VGL.

In an embodiment, when the fifth PMOS transistor PT5 of the pull-down circuit is turned on by the low level VGL of the signal of the third node N3, the output signal OUT starts to decrease from the high level VGH to the low level VGL by the pull-down operation of the pull-down circuit PD. At this time, the second capacitor C2 maintains the voltage difference between both electrodes of the second capacitor C2 so that the voltage level of the first electrode (the third node N3) of the second capacitor C2 may be reduced to a level lower than the VGL (e.g. 2VGL) as the output signal OUT decreases.

In an embodiment, the low level of the third node N3 becomes the voltage (e.g. 2VGL) that is lower than the second power voltage VGL in the pull-down operation so that the pull-down circuit PD may be further sufficiently turned on, and accordingly, so that the reliability of the operation of the pull-down circuit PD may be enhanced.

In an embodiment, when the voltage level of the first electrode (the third node N3) of the second capacitor C2 decreases to the level (e.g. 2VGL) which is lower than VGL, the sixth PMOS transistor PT6 is configured to be turned off so that the fifth PMOS transistor PT5 may be continuously turned on.

If the sixth PMOS transistor PT6 does not exist, the third NMOS transistor NT3 may be turned on when the voltage level of the first electrode (the third node N3) of the second capacitor C2 decreases to the level (e.g. 2VGL) which is lower than VGL. When the third NMOS transistor NT3 is turned on, VGL is applied to the third node N3 so that the voltage level of the third node N3 may not be decreased to the level (e.g. 2VGL) that is lower than VGL.

In an embodiment, when the voltage level of the third node N3 decreases to the level (e.g. 2VGL) which is lower than VGL, the third node N3 and the fourth node N4 are disconnected by the sixth PMOS transistor PT6 so that the reliability of the operation of the pull-down circuit PD may be guaranteed.

In an embodiment, the pull-up circuit PU may include a fourth PMOS transistor PT4 including a control electrode connected to the second node N2, a first electrode receiving the first power voltage VGH and a second electrode connected to the output node.

In an embodiment, the pull-down circuit PD may include the fifth PMOS transistor PT5 including a control electrode connected to the third node N3, a first electrode connected to the output node and a second electrode receiving the second power voltage VGL.

In an embodiment, the pull-down circuit PD does not include the NMOS transistor but does include the PMOS transistor so that a negative shift of a threshold voltage of the NMOS transistor does not occur and so that an increase of dead space of the display panel 100 due to an increase of a size of the NMOS transistor of the pull-down circuit PD for compensating a mobility of the NMOS transistor does not occur.

According to an embodiment, at least one stage may include the inverters INV1 and INV2, where at least one of the inverters INV1 and INV2 may include the PMOS (P-type metal oxide semiconductor) transistor and the NMOS (N-type metal oxide semiconductor) transistor and where the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In an embodiment, the pull-down circuit PD of the stage includes the PMOS transistor PT5 having a high reliability and a high mobility so that the reliability of the driver may be enhanced and the dead space of the display panel 100 may be reduced.

In an embodiment, the low level of the signal applied to the control electrode of the pull-down circuit PD is the voltage (e.g. 2VGL) which is lower than the second power voltage VGL applied to the second electrode of the pull-down circuit PD so that the pull-down circuit PD may be sufficiently turned on and accordingly, the reliability of the driver may be further enhanced.

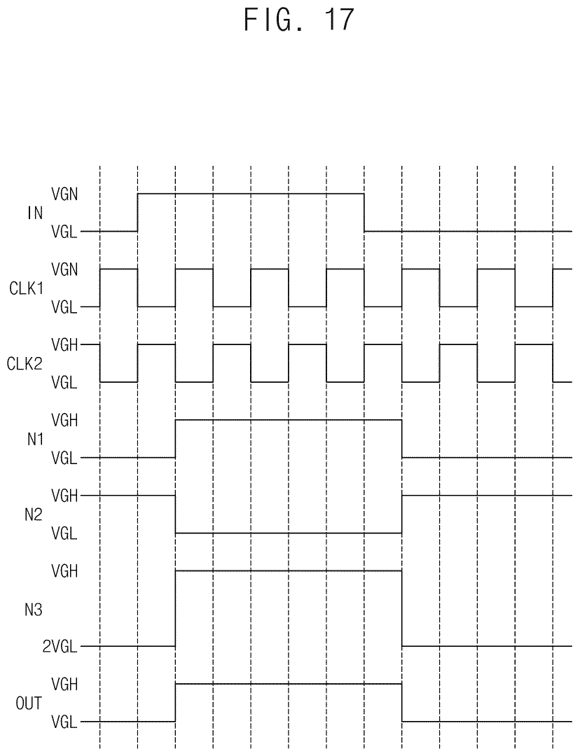

FIG. 18 is a circuit diagram illustrating a stage of a driver of a display apparatus, according to an embodiment.

The driver and the display apparatus, including the driver according to the present embodiment, are substantially the same as the driver and the display apparatus including the driver of the previous embodiment explained referring to FIGS. 16 and 17 with the exception of the circuit structure of the delay circuit. Thus, the same reference numerals will be used to refer to the same or like parts as those described in the previous embodiment of FIGS. 16 and 17 and any repetitive explanation concerning the above elements will be omitted.

In an embodiment and referring to FIGS. 1 to 3, 6 to 11, 17 and 18, the display apparatus includes a display panel 100 and a display panel driver. The display panel driver includes a driving controller 200, a gate driver 300, a gamma reference voltage generator 400, a data driver 500 and an emission driver 600.

In an embodiment, the driver may be the gate driver 300 outputting the gate signal in FIG. 2A. In an embodiment, the driver may be the emission driver 600 outputting the emission signal in FIG. 2B. As such, a driver circuit according to the invention may be applied to the gate driver 300 and the emission driver 600.

In an embodiment, the stage of the driver includes a delay circuit DEL, a first inverter INV1, a second inverter INV2, a pull-up circuit PU and a pull-down circuit PD.

In an embodiment, the stage may further include a first capacitor C1 including a first electrode receiving the first power voltage VGH and a second electrode connected to the first node N1.

In an embodiment, the delay circuit DEL may include a first PMOS transistor PT1 including a control electrode receiving the second clock signal CLK2, a first electrode receiving the input signal IN and a second electrode connected to the first node N1.

Even if the delay circuit DEL includes only one transistor PT1, the delay circuit DEL may perform substantially the same operation as the delay circuit DEL of FIG. 16. Thus, when the delay circuit DEL includes only one transistor PT1 as illustrated in FIG. 18, the number of transistors may be reduced and the dead space of the display panel 100 may be reduced.

In an embodiment, t, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the second power voltage VGL.

In an embodiment, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to a fourth node N4 and a second electrode receiving the second power voltage VGL.

In an embodiment, the second inverter INV2 may further include a sixth PMOS transistor PT6 including a control electrode connected to the fourth node N4, a first electrode connected to the third node N3 and a second electrode connected to the fourth node N4.

In an embodiment, the stage of the driver may further include a second capacitor C2 including a first electrode connected to the third node N3 and a second electrode connected to an output node.

In an embodiment, the low level of the third node N3 becomes the voltage (e.g. 2VGL) that is lower than the second power voltage VGL in the pull-down operation so that the pull-down circuit PD may be further sufficiently turned on, and accordingly, so that the reliability of the operation of the pull-down circuit PD may be enhanced.

In an embodiment, the pull-up circuit PU may include a fourth PMOS transistor PT4 including a control electrode connected to the second node N2, a first electrode receiving the first power voltage VGH and a second electrode connected to an output node.

In an embodiment, t, the pull-down circuit PD may include a fifth PMOS transistor PT5 including a control electrode connected to the third node N3, a first electrode connected to the output node and a second electrode receiving the second power voltage VGL.

In an embodiment, the pull-down circuit PD does not include the NMOS transistor but does include the PMOS transistor so that a negative shift of a threshold voltage of the NMOS transistor does not occur and so that an increase of dead space of the display panel 100 due to an increase of a size of the NMOS transistor of the pull-down circuit PD for compensating a mobility of the NMOS transistor does not occur.

According to an embodiment, at least one stage may include the inverters INV1 and INV2, wherein at least one of the inverters INV1 and INV2 may include the PMOS (P-type metal oxide semiconductor) transistor and the NMOS (N-type metal oxide semiconductor) transistor and wherein the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In an embodiment, the pull-down circuit PD of the stage includes the PMOS transistor PT5 having a high reliability and a high mobility so that the reliability of the driver may be enhanced and the dead space of the display panel 100 may be reduced.

In an embodiment, the low level of the signal applied to the control electrode of the pull-down circuit PD is the voltage (e.g. 2VGL) which is lower than the second power voltage VGL applied to the second electrode of the pull-down circuit PD so that the pull-down circuit PD may be sufficiently turned on and accordingly, so that the reliability of the driver may be further enhanced.

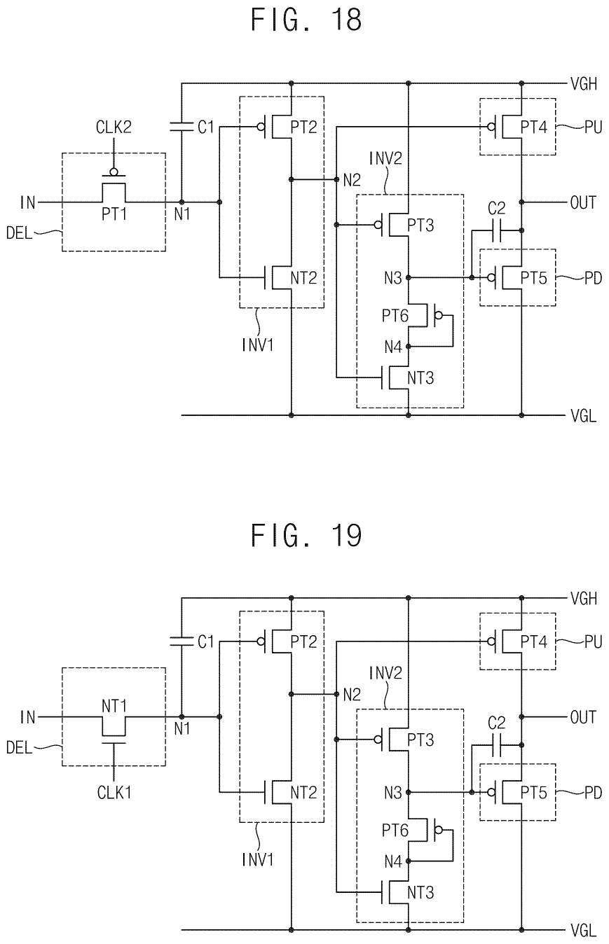

FIG. 19 is a circuit diagram illustrating a stage of a driver of a display apparatus, according to an embodiment.

The driver and the display apparatus, including the driver according to the present embodiment, are substantially the same as the driver and the display apparatus including the driver of the previous embodiment explained referring to FIGS. 16 and 17 except for the circuit structure of the delay circuit. Thus, the same reference numerals will be used to refer to the same or like parts as those described in the previous embodiment of FIGS. 16 and 17 and any repetitive explanation concerning the above elements will be omitted.

In an embodiment and referring to FIGS. 1 to 3, 6 to 11, 17 and 19, the display apparatus includes a display panel 100 and a display panel driver, where the display panel driver includes a driving controller 200, a gate driver 300, a gamma reference voltage generator 400, a data driver 500 and an emission driver 600.

In an embodiment, the driver may be the gate driver 300 outputting the gate signal in FIG. 2A. In an embodiment, the driver may be the emission driver 600 outputting the emission signal in FIG. 2B. As such, a driver circuit according to the invention may be applied to the gate driver 300 and the emission driver 600.

In an embodiment, the stage of the driver includes a delay circuit DEL, a first inverter INV1, a second inverter INV2, a pull-up circuit PU and a pull-down circuit PD.

In an embodiment, the stage may further include a first capacitor C1 including a first electrode receiving the first power voltage VGH and a second electrode connected to the first node N1.

In an embodiment, the delay circuit DEL may include a first NMOS transistor NT1 including a control electrode receiving the first clock signal CLK1, a first electrode receiving the input signal IN and a second electrode connected to the first node N1.

Even if the delay circuit DEL includes only one transistor NT1, the delay circuit DEL may perform substantially the same operation as the delay circuit DEL of FIG. 16. Thus, when the delay circuit DEL includes only one transistor NT1 as illustrated in FIG. 19, the number of transistors may be reduced and the dead space of the display panel 100 may be reduced.

In an embodiment, the first inverter INV1 may include a second PMOS transistor PT2 including a control electrode connected to the first node N1, a first electrode receiving the first power voltage VGH and a second electrode connected to the second node N2 and a second NMOS transistor NT2 including a control electrode connected to the first node N1, a first electrode connected to the second node N2 and a second electrode receiving the second power voltage VGL.

In an embodiment, the second inverter INV2 may include a third PMOS transistor PT3 including a control electrode connected to the second node N2, a first electrode receiving the first power voltage VGH and a second electrode connected to the third node N3 and a third NMOS transistor NT3 including a control electrode connected to the second node N2, a first electrode connected to a fourth node N4 and a second electrode receiving the second power voltage VGL.

In an embodiment, the second inverter INV2 may further include a sixth PMOS transistor PT6 including a control electrode connected to the fourth node N4, a first electrode connected to the third node N3 and a second electrode connected to the fourth node N4.

In an embodiment, the stage of the driver may further include a second capacitor C2 including a first electrode connected to the third node N3 and a second electrode connected to an output node.

In an embodiment, the low level of the third node N3 becomes the voltage (e.g. 2VGL) that is lower than the second power voltage VGL in the pull-down operation so that the pull-down circuit PD may be further sufficiently turned on, and accordingly, so that the reliability of the operation of the pull-down circuit PD may be enhanced.

In an embodiment, the pull-up circuit PU may include a fourth PMOS transistor PT4 including a control electrode connected to the second node N2, a first electrode receiving the first power voltage VGH and a second electrode connected to an output node.

In an embodiment, the pull-down circuit PD may include a fifth PMOS transistor PT5 including a control electrode connected to the third node N3, a first electrode connected to the output node and a second electrode receiving the second power voltage VGL.

In an embodiment, the pull-down circuit PD does not include the NMOS transistor but does include the PMOS transistor so that a negative shift of a threshold voltage of the NMOS transistor does not occur and so that an increase of dead space of the display panel 100 due to an increase of a size of the NMOS transistor of the pull-down circuit PD for compensating a mobility of the NMOS transistor does not occur.

According to an embodiment, at least one stage may include the inverters INV1 and INV2, wherein at least one of the inverters INV1 and INV2 may include the PMOS (P-type metal oxide semiconductor) transistor and the NMOS (N-type metal oxide semiconductor) transistor and wherein the material of the active area of the PMOS transistor included in the at least one of the inverters INV1 and INV2 may be different from the material of the active area of the NMOS transistor included in the at least one of the inverters INV1 and INV2. Accordingly, the power consumption of the driver and the display apparatus may be reduced.

In an embodiment, the pull-down circuit PD of the stage includes the PMOS transistor PT5 having a high reliability and a high mobility so that the reliability of the driver may be enhanced and so that the dead space of the display panel 100 may be reduced.

In an embodiment, the low level of the signal applied to the control electrode of the pull-down circuit PD is the voltage (e.g. 2VGL) which is lower than the second power voltage VGL applied to the second electrode of the pull-down circuit PD so that the pull-down circuit PD may be sufficiently turned on and accordingly, so that the reliability of the driver may be further enhanced.

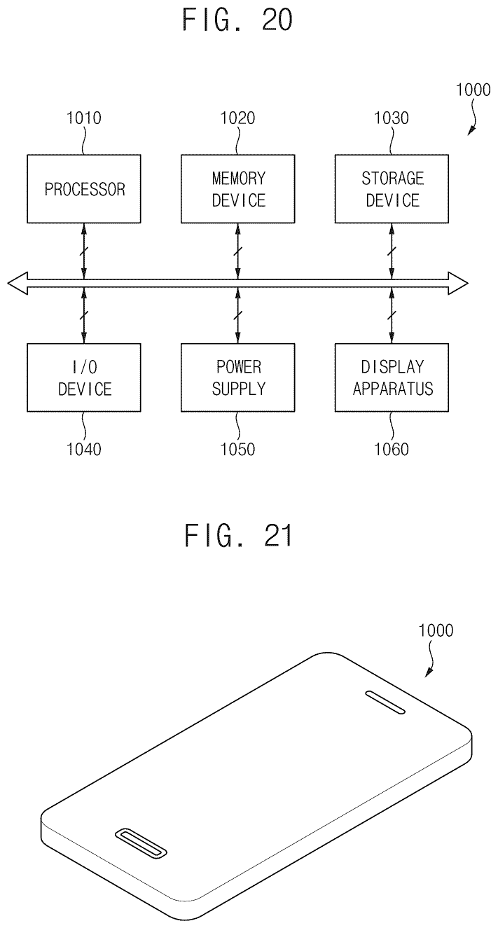

FIG. 20 is a block diagram illustrating an electronic apparatus 1000, according to an embodiment. FIG. 21 is a diagram illustrating an example in which the electronic apparatus 1000 of FIG. 20 is implemented as a smart phone, according to an embodiment.

In an embodiment and referring to FIGS. 1 to 21, the electronic apparatus 1000 may include a processor 1010, a memory device 1020, a storage device 1030, an input/output (I/O) device 1040, a power supply 1050 and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 21, the electronic apparatus 1000 may be implemented as a smart phone. However, the electronic apparatus 1000 is not limited thereto. For example, in another embodiment the electronic apparatus 1000 may be implemented as a cellular phone, a video phone, a smart pad, a smart watch, a tablet PC, a car navigation system, a computer monitor, a laptop, a head mounted display (HMD) device, and the like.

In an embodiment, the processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

In an embodiment, the memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

In an embodiment, the storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

According to the driver and the display apparatus, including the driver of the present embodiment as explained above, the power consumption of the display apparatus may be reduced, the reliability of the driver may be enhanced and the dead space of the display panel may be reduced.

The foregoing is illustrative of the invention and is not to be construed as limiting thereof. Although a few example embodiments of the invention have been described, those skilled in the art will readily appreciate that many modifications are possible in the invention without materially departing from the novel teachings and advantages of the invention. Accordingly, all such modifications are intended to be included within the scope of the invention. Therefore, it is to be understood that the foregoing is illustrative of the invention and is not to be construed as limited to the specific example embodiments disclosed, and that modifications to the disclosed example embodiments, as well as other example embodiments, are intended to be included within the scope of the invention. Moreover, the embodiments or parts of the embodiments may be combined in whole or in part without departing from the scope of the invention.

What is claimed is:

1. A driver comprising:
a delay circuit configured to receive an input signal and at least one of a first clock signal and a second clock signal and output the input signal to a first node in response to the at least one of the first clock signal and the second clock signal;
a first inverter configured to invert a signal of the first node and output an inverted signal of the signal of the first node to a second node;
a second inverter configured to invert a signal of the second node and output an inverted signal of the signal of the second node to a third node;
a pull-up circuit configured to pull up an output signal to a first power voltage in response to the signal of the second node; and
a pull-down circuit configured to pull down the output signal to a second power voltage in response to the signal of the third node,
wherein the first inverter includes at least one NMOS transistor, and
wherein the second inverter includes at least one NMOS transistor.

2. The driver of claim 1, wherein the delay circuit comprises:
a first PMOS transistor including a control electrode configured to receive the second clock signal, a first electrode configured to receive the input signal, and a second electrode connected to the first node; and
a first NMOS transistor including a control electrode configured to receive the first clock signal, a first electrode configured to receive the input signal, and a second electrode connected to the first node.

3. The driver of claim 1, wherein the delay circuit comprises:
a first PMOS transistor including a control electrode configured to receive the second clock signal, a first electrode configured to receive the input signal, and a second electrode connected to the first node.

4. The driver of claim 1, wherein the delay circuit comprises:
a first NMOS transistor including a control electrode configured to receive the first clock signal, a first electrode configured to receive the input signal, and a second electrode connected to the first node.

5. The driver of claim 1, wherein the first inverter comprises:
a second PMOS transistor including a control electrode connected to the first node, a first electrode configured to receive the first power voltage, and a second electrode connected to the second node; and
a second NMOS transistor including a control electrode connected to the first node, a first electrode connected to the second node and a second electrode configured to receive the second power voltage.

6. The driver of claim 5, wherein a material of an active area of the second PMOS transistor is different from a material of an active area of the second NMOS transistor.

7. The driver of claim 6, wherein the active area of the second PMOS transistor includes a polycrystalline silicon, and
wherein the active area of the second NMOS transistor includes an oxide semiconductor.

8. The driver of claim 1, wherein the second inverter comprises:
a third PMOS transistor including a control electrode connected to the second node, a first electrode configured to receive the first power voltage, and a second electrode connected to the third node; and
a third NMOS transistor including a control electrode connected to the second node, a first electrode connected to the third node and a second electrode configured to receive a third power voltage that is lower than the second power voltage.

9. The driver of claim 8, wherein a material of an active area of the third PMOS transistor is different from a material of an active area of the third NMOS transistor.

10. The driver of claim 1, wherein the pull-up circuit comprises:
a fourth PMOS transistor including a control electrode connected to the second node, a first electrode configured to receive the first power voltage, and a second electrode connected to an output node.

11. The driver of claim 1, wherein the pull-down circuit comprises:
a fifth PMOS transistor including a control electrode connected to the third node, a first electrode connected to an output node and a second electrode configured to receive the second power voltage.

12. The driver of claim 1, wherein the driver comprises:
a first PMOS transistor including a control electrode configured to receive the second clock signal, a first electrode configured to receive the input signal, and a second electrode connected to the first node;
a first NMOS transistor including a control electrode configured to receive the first clock signal, a first electrode configured to receive the input signal, and a second electrode connected to the first node;
a second PMOS transistor including a control electrode connected to the first node, a first electrode configured to receive the first power voltage, and a second electrode connected to the second node;
a second NMOS transistor including a control electrode connected to the first node, a first electrode connected to the second node and a second electrode configured to receive the second power voltage;
a third PMOS transistor including a control electrode connected to the second node, a first electrode configured to receive the first power voltage, and a second electrode connected to the third node;
a third NMOS transistor including a control electrode connected to the second node, a first electrode connected to the third node and a second electrode configured to receive a third power voltage that is lower than the second power voltage;
a fourth PMOS transistor including a control electrode connected to the second node, a first electrode configured to receive the first power voltage, and a second electrode connected to an output node;
a fifth PMOS transistor including a control electrode connected to the third node, a first electrode connected to the output node and a second electrode configured to receive the second power voltage; and
a first capacitor including a first electrode configured to receive the first power voltage and a second electrode connected to the first node.

13. The driver of claim 1, wherein the first inverter comprises:
a second PMOS transistor including a control electrode connected to the first node, a first electrode configured to receive the first power voltage, and a second electrode connected to the second node; and
a second NMOS transistor including a control electrode connected to the first node, a first electrode connected to the second node and a second electrode configured to receive a third power voltage that is lower than the second power voltage.

14. The driver of claim 1, wherein the second inverter comprises:
a third PMOS transistor including a control electrode connected to the second node, a first electrode configured to receive the first power voltage, and a second electrode connected to the third node; and
a third NMOS transistor including a control electrode connected to the second node, a first electrode connected to a fourth node and a second electrode configured to receive the second power voltage.

15. The driver of claim 14, wherein the second inverter further comprises:
a sixth PMOS transistor including a control electrode connected to the fourth node, a first electrode connected to the third node and a second electrode connected to the fourth node.

16. The driver of claim 14, further comprising:
a second capacitor including a first electrode connected to the third node and a second electrode connected to an output node.

17. The driver of claim 1, wherein the driver comprises:
a first PMOS transistor including a control electrode configured to receive the second clock signal, a first electrode configured to receive the input signal, and a second electrode connected to the first node;
a first NMOS transistor including a control electrode configured to receive the first clock signal, a first electrode configured to receive the input signal, and a second electrode connected to the first node;
a second PMOS transistor including a control electrode connected to the first node, a first electrode configured to receive the first power voltage, and a second electrode connected to the second node;
a second NMOS transistor including a control electrode connected to the first node, a first electrode connected to the second node and a second electrode configured to receive the second power voltage;
a third PMOS transistor including a control electrode connected to the second node, a first electrode configured to receive the first power voltage, and a second electrode connected to the third node;
a sixth PMOS transistor including a control electrode connected to a fourth node, a first electrode connected to the third node and a second electrode connected to the fourth node;
a third NMOS transistor including a control electrode connected to the second node, a first electrode connected to the fourth node and a second electrode configured to receive the second power voltage;
a fourth PMOS transistor including a control electrode connected to the second node, a first electrode configured to receive the first power voltage, and a second electrode connected to an output node;
a fifth PMOS transistor including a control electrode connected to the third node, a first electrode connected to the output node and a second electrode configured to receive the second power voltage;
a first capacitor including a first electrode configured to receive the first power voltage, and a second electrode connected to the first node; and
a second capacitor including a first electrode connected to the third node, and a second electrode connected to the output node.

18. A display apparatus comprising:
a display panel comprising a pixel;
a gate driver configured to output a gate signal to the pixel;
a data driver configured to output a data voltage to the pixel; and
an emission driver configured to output an emission signal to the pixel,
wherein the gate driver includes at least one stage,
wherein the at least one stage comprises:
a delay circuit configured to receive an input signal and at least one of a first clock signal and a second clock signal and output the input signal to a first node in response to the at least one of the first clock signal and the second clock signal;
a first inverter configured to invert a signal of the first node and output an inverted signal of the signal of the first node to a second node;
a second inverter configured to invert a signal of the second node and output an inverted signal of the signal of the second node to a third node;
a pull-up circuit configured to pull up an output signal to a first power voltage in response to the signal of the second node; and
a pull-down circuit configured to pull down the output signal to a second power voltage in response to the signal of the third node,
wherein the first inverter includes at least one NMOS transistor, and
wherein the second inverter includes at least one NMOS transistor.

19. The display apparatus of claim 18, wherein the pixel comprises a P-type switching element and an N-type switching element.

20. The display apparatus of claim 19, wherein the pixel comprises:
a first pixel switching element including a control electrode connected to a first pixel node, a first electrode connected to a second pixel node and a second electrode connected to a third pixel node;
a second pixel switching element including a control electrode configured to receive a writing gate signal, a first electrode configured to receive the data voltage, and a second electrode connected to the second pixel node;
a third pixel switching element including a control electrode configured to receive a compensation gate signal, a first electrode connected to the first pixel node and a second electrode connected to the third pixel node;
a fourth pixel switching element including a control electrode configured to receive a data initialization gate signal, a first electrode configured to receive an initialization voltage, and a second electrode connected to the first pixel node;
a fifth pixel switching element including a control electrode configured to receive the emission signal, a first electrode configured to receive a high power voltage and a second electrode connected to the second pixel node;
a sixth pixel switching element including a control electrode configured to receive the emission signal, a first electrode connected to the third pixel node and a second electrode connected to an anode electrode of a light emitting element;
a seventh pixel switching element including a control electrode configured to receive a light emitting element initialization gate signal, a first electrode configured to receive the initialization voltage, and a second electrode connected to the anode electrode of the light emitting element;
a storage capacitor including a first electrode configured to receive the high power voltage, and a second electrode connected to the first pixel node; and
the light emitting element including the anode electrode and a cathode electrode configured to receive a low power voltage.

21. The display apparatus of claim 20, wherein the third pixel switching element and the fourth pixel switching element are N-type transistors,
wherein the first pixel switching element, the second pixel switching element, the fifth pixel switching element, the sixth pixel switching element and the seventh pixel switching element are P-type transistors, and
wherein the output signal of the at least one stage is the compensation gate signal.

22. The display apparatus of claim 20, wherein the third pixel switching element and the fourth pixel switching element are N-type transistors,
wherein the first pixel switching element, the second pixel switching element, the fifth pixel switching element, the sixth pixel switching element and the seventh pixel switching element are P-type transistors, and
wherein the output signal of the at least one stage is the compensation gate signal and the data initialization gate signal.

23. The display apparatus of claim 22, wherein the data initialization gate signal has a timing that is earlier than a timing of the compensation gate signal in a frame.

24. The display apparatus of claim 20, wherein the third pixel switching element, the fourth pixel switching element and the seventh pixel switching element are N-type transistors,
wherein the first pixel switching element, the second pixel switching element, the fifth pixel switching element and the sixth pixel switching element are P-type transistors, and
wherein the output signal of the at least one stage is the compensation gate signal.

25. The display apparatus of claim 20, wherein the third pixel switching element, the fourth pixel switching element and the seventh pixel switching element are N-type transistors,
wherein the first pixel switching element, the second pixel switching element, the fifth pixel switching element and the sixth pixel switching element are P-type transistors, and
wherein the output signal of the at least one stage is the compensation gate signal, the data initialization gate signal and the light emitting element initialization gate signal.

26. A display apparatus comprising:
a display panel comprising a pixel;
a gate driver configured to output a gate signal to the pixel;
a data driver configured to output a data voltage to the pixel; and
an emission driver configured to output an emission signal to the pixel,
wherein the emission driver includes at least one stage,
wherein the at least one stage of the emission driver comprises:
a delay circuit configured to receive an input signal and at least one of a first clock signal and a second clock signal and output the input signal to a first node in response to the at least one of the first clock signal and the second clock signal;
a first inverter configured to invert a signal of the first node and output an inverted signal of the signal of the first node to a second node;
a second inverter configured to invert a signal of the second node and output an inverted signal of the signal of the second node to a third node;
a pull-up circuit configured to pull up an output signal to a first power voltage in response to the signal of the second node; and
a pull-down circuit configured to pull down the output signal to a second power voltage in response to the signal of the third node,
wherein the first inverter includes at least one NMOS transistor, and
wherein the second inverter includes at least one NMOS transistor.
